(19) United States
(12) Patent Application Publication
(10) Pub. No.: US 2006/0235745 A1
(43) Pub. Date: Oct. 19, 2006

(54) TREND-CREATION-TYPE ADVERTISING SYSTEM, TREND-CREATION-TYPE ADVERTISING METHOD, AND COMPUTER PRODUCT

(76) Inventor: Takashi YANO, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/279,449

(22) Filed: Apr. 12, 2006

(30) Foreign Application Priority Data
Apr. 14, 2005 (JP) 2005-117222

(51) Int. Cl. G06Q 30/00

(52) U.S. Cl. 705/14

(57) ABSTRACT

A buzzword voting manager manages vote points of each sponsor for each of buzzword candidates selected in advance, and decides buzzwords based on the vote points. A buzzword acquiring unit selects a buzzword to be displayed based on a preset criterion from among the decided buzzwords. A portal unit generates a hypertext content that includes a buzzword list or a sentence including the selected buzzword, and transfers the generated hypertext content to a user terminal. A search engine unit receives a search request with the buzzword as a keyword, and transfers a search result of contents on a website to a source of the search request.

### CROSS-REFERENCE TO RELATED APPLICATIONS

The present document incorporates by reference the entire contents of Japanese priority document, 2005-117222 filed in Japan on Apr. 14, 2005.

### BACKGROUND OF THE INVENTION

1. Field of the Invention

The present invention relates to a trend-creation-type advertising model based on a push keyword for a provider that provides a portal site and a search engine service.

2. Description of the Related Art

Portal pages provided by a portal site are a media that cover much information in which users are considered to be interested and that are accessed by a vast number of people. This portal site is constituted by many contents including information such as news, weather forecast, and featured articles, commercial services such as Internet shopping and auctions, entertainment contents such as astrology and games, advertisements, advertising articles, and the like.

These contents are hyperlinked to one another in hypertext so that each user can view only what he or she is interested in among such many contents.

One of those portal pages is a push search service realized by a technique disclosed in Japanese Patent Application Laid-open No. 2000-2906 or the like. This service is put to practical use as “words of concern” in the MSN portal site, “words of interest” in the NTT Group's “goo” portal site, or the like.

On the portal pages, buzzwords (potentially popular keywords) are listed and the buzzwords serve as respective buttons in the hypertext. If a user clicks on one of these buzzwords, the terminal of a user site requests a search engine to do a search with the buzzword used as a keyword.

According to the conventional hypertext, what is displayed when the user clicks on the buzzword is fixed at the time of creating links. According to the push search service, differently from the conventional hypertext, what is displayed when the user clicks on the buzzword is a search result obtained by using the clicked-on phrase as the keyword.

Although a growth rate of Internet advertisement is decreasing as a whole, sponsored search services such as Google AdWords show rapid growth.

Meanwhile, while each portal site is filled with large amounts of advertisements, all of these advertisements are not viewed by users but it is more likely that the users do not view all of them.

Accordingly, for advertisement on the portal site, emergence of an advertising model that can make effective use of Internet properties such as the sponsored search services is desired.

Many trends have been created in the Internet world. However, since they result from user's information distribution and information propagation, the advertisement can hardly be involved in the trends. On the contrary, the things which are not advertised have created trends by word-of-mouth communication.

Despite recognition that it is quite effective for advertisement to create a trend, no mechanisms for cooperation of the trend with the advertisement have been proposed so far.

### SUMMARY OF THE INVENTION

It is an object of the present invention to at least partially solve the problems in the conventional technology.

A trend-creation-type advertising system according to one aspect of the present invention includes a buzzword voting manager that manages vote points of each sponsor for each of buzzword candidates selected in advance, and that decides buzzwords based on the vote points; a buzzword acquiring unit that selects a buzzword to be displayed based on a preset criterion from among the decided buzzwords; a portal unit that generates a hypertext content that includes a buzzword list or a sentence including the buzzword selected by the buzzword acquiring unit, and that transfers the generated hypertext content to a user terminal; and a search engine unit that receives a search request with the buzzword as a keyword when a user clicks on the buzzword list or the buzzword in the sentence, and that transfers a search result of contents on a website to a source of the search request.

A trend-creation-type advertising system according to another aspect of the present invention includes a buzzword-candidate collecting unit that collects keywords having high increments in number of times of appearance as buzzword candidates from among keywords in search conditions or contents; a buzzword voting manager that manages vote points of each sponsor for each of the buzzword candidates collected by the buzzword collecting unit, and that decides buzzwords based on the vote points; a buzzword acquiring unit that selects a buzzword to be displayed based on a preset criterion from among the decided buzzwords; a portal unit that generates a hypertext content that includes a buzzword list or a sentence including the buzzword selected by the buzzword acquiring unit, and that transfers the generated hypertext content to a user terminal; and a search engine unit that receives a search request with the buzzword as a keyword when a user clicks on the buzzword list or the buzzword in the sentence, and that transfers a search result of contents on a website to a source of the search request.

A trend-creation-type advertising system according to still another aspect of the present invention includes a buzzword voting manager that manages vote points of each sponsor for each of buzzword candidates registered by the each sponsor, and that decides buzzwords based on the vote points; a buzzword acquiring unit that selects a buzzword to be displayed based on a preset criterion from among the decided buzzwords; a portal unit that generates a hypertext content that includes a buzzword list or a sentence including the buzzword selected by the buzzword acquiring unit, and that transfers the generated hypertext content to a user terminal; and a search engine unit that receives a search request with the buzzword as a keyword when a user clicks on the buzzword list or the buzzword in the sentence, and that transfers a search result of contents on a website to a source of the search request.

A trend-creation-type advertising method according to still another aspect of the present invention includes managing vote points of each sponsor for each of buzzword candidates selected in advance; deciding buzzwords based on the vote points; selecting a buzzword to be displayed based on a preset criterion from among the decided buzzwords; generating a hypertext content that includes a buzzword list or a sentence including the buzzword selected at the selecting; transferring the generated hypertext content to a user terminal; receiving a search request with the buzzword as a keyword when a user clicks on the buzzword list or the buzzword in the sentence; and transferring a search result of contents on a website to a source of the search request.

A trend-creation-type advertising method according to still another aspect of the present invention includes collecting keywords having high increments in number of times of appearance as buzzword candidates from among keywords in search conditions or contents; managing vote points of each sponsor for each of the buzzword candidates collected at the collecting; deciding buzzwords based on the vote points; selecting a buzzword to be displayed based on a preset criterion from among the decided buzzwords; generating a hypertext content that includes a buzzword list or a sentence including the buzzword selected at the selecting; transferring the generated hypertext content to a user terminal; receiving a search request with the buzzword as a keyword when a user clicks on the buzzword list or the buzzword in the sentence; and transferring a search result of contents on a website to a source of the search request.

A trend-creation-type advertising method according to still another aspect of the present invention includes managing vote points of each sponsor for each of buzzword candidates registered by the each sponsor; deciding buzzwords based on the vote points; selecting a buzzword to be displayed based on a preset criterion from among the decided buzzwords; generating a hypertext content that includes a buzzword list or a sentence including the buzzword selected at the selecting; transferring the generated hypertext content to a user terminal; receiving a search request with the buzzword as a keyword when a user clicks on the buzzword list or the buzzword in the sentence; and transferring a search result of contents on a website to a source of the search request.

A computer-readable recording medium according to still another aspect of the present invention stores a computer program for a trend-creation-type advertising system. The computer program causes a computer to execute managing vote points of each sponsor for each of buzzword candidates selected in advance; deciding buzzwords based on the vote points; selecting a buzzword to be displayed based on a preset criterion from among the decided buzzwords; generating a hypertext content that includes a buzzword list or a sentence including the buzzword selected at the selecting; transferring the generated hypertext content to a user terminal; receiving a search request with the buzzword as a keyword when a user clicks on the buzzword list or the buzzword in the sentence; and transferring a search result of contents on a website to a source of the search request.

A computer-readable recording medium according to still another aspect of the present invention stores a computer program for a trend-creation-type advertising system. The computer program causes a computer to execute collecting keywords having high increments in number of times of appearance as buzzword candidates from among keywords in search conditions or contents; managing vote points of each sponsor for each of the buzzword candidates collected at the collecting; deciding buzzwords based on the vote points; selecting a buzzword to be displayed based on a preset criterion from among the decided buzzwords; generating a hypertext content that includes a buzzword list or a sentence including the buzzword selected at the selecting; transferring the generated hypertext content to a user terminal; receiving a search request with the buzzword as a keyword when a user clicks on the buzzword list or the buzzword in the sentence; and transferring a search result of contents on a website to a source of the search request.

A computer-readable recording medium according to still another aspect of the present invention stores a computer program for a trend-creation-type advertising system. The computer program causes a computer to execute managing vote points of each sponsor for each of buzzword candidates registered by the each sponsor; deciding buzzwords based on the vote points; selecting a buzzword to be displayed based on a preset criterion from among the decided buzzwords; generating a hypertext content that includes a buzzword list or a sentence including the buzzword selected at the selecting; transferring the generated hypertext content to a user terminal; receiving a search request with the buzzword as a keyword when a user clicks on the buzzword list or the buzzword in the sentence; and transferring a search result of contents on a website to a source of the search request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a basic configuration of a trend-creation-type advertising system according to a first embodiment of the present invention;

FIG. 2 is an explanatory view of roles of respective sites in the trend-creation-type advertising system according to the first embodiment;

FIG. 3 is a block diagram of a functional configuration of a portal site according to the first embodiment;

FIG. 4 is a block diagram of a functional configuration of a buzzword voting manager according to the first embodiment;

FIG. 5 is an example of a data structure of a buzzword candidate database according to the first embodiment;

FIG. 6 is a block diagram of a functional configuration of a portal unit according to the first embodiment;

FIG. 7 is an example of displaying a buzzword list;

FIG. 8 is a block diagram of another functional configuration of the portal unit according to the first embodiment;

FIG. 9 is another block diagram of another functional configuration of the portal unit according to the first embodiment;

FIG. 10 is a block diagram of a functional configuration of a buzzword voting manager according to a second embodiment of the present invention;

FIG. 11 is a block diagram of a functional configuration of a buzzword voting manager according to a third embodiment of the present invention;

FIG. 12 is an example of a data structure of a buzzword candidate table according to the third embodiment;

FIG. 13 is an example of a buzzword voting table according to a fourth embodiment of the present invention;

FIG. 14 is another example of the buzzword voting table according to the fourth embodiment;

FIG. 15 is a block diagram of a functional configuration of a portal unit according to a fifth embodiment of the present invention;

FIG. 16 is an example of displaying personalized buzzwords;

FIG. 17 is an example of displaying a click counter adjacent to each buzzword;

FIG. 18 is an example of displaying a categorized buzzword list;

FIG. 19 is an example of a data structure of an auxiliary keyword table;

FIG. 20 is an example of a data structure of a sponsor keyword table;

FIG. 21 is an example of a sponsor voting result; and

FIG. 22 is a block diagram of a functional configuration of a portal site according to a ninth embodiment of the present invention (in which configuration same functional constituent elements as those according to the first to eighth embodiments are not shown).

### DETAILED DESCRIPTION OF THE PREFERRED EMBODIMENTS

Exemplary embodiments of the present invention will be explained below in detail with reference to the accompanying drawings.

A potentially popular keyword will be referred to as “a buzzword candidate” which is a sponsor's voting target. Which of the buzzword candidates becomes a buzzword has an effect on an advertisement of a company and sales of products and services of the company. Therefore, voting is a commercial behavior and needs to be done for value equivalent. A voter, who is called “sponsor”, can vote for an arbitrary buzzword candidate by arbitrary vote points, and pays a value in compensation for the vote points.

The buzzword is a keyword selected from among buzzword candidates according to votes of respective sponsors. This buzzword is displayed when each user accesses a portal site or when a search result is displayed by a search service. It is noted that all buzzwords are not simultaneously displayed, but that some buzzwords are selected from among the buzzword candidates based on a preset criterion whenever the result is displayed.

If a user does a search only with a buzzword (keyword), an unnecessary search result is obtained. To avoid this, an auxiliary keyword is made correspond to the buzzword in advance so that the search engine does a search by the buzzword (keyword) as well as its corresponding keyword if the user requests the search engine to do a search.

Each sponsor can apply for and register this auxiliary keyword so that pages of the sponsor site are included in a search result. This auxiliary keyword is referred to as “sponsor keyword”.

Various sponsors register sponsor keywords for one buzzword so as to introduce users to their respective sites. Due to this, if a buzzword is selected, then all of the sponsor keywords corresponding to the buzzword are not used but one of the sponsor keywords to be used is selected based on a preset criterion.

The advertisement content is a content applied for and registered by each sponsor. If a buzzword is selected, one sponsor keyword to be used is selected and prepared based on the preset criterion from among the corresponding sponsor keywords. If a user clicks on a buzzword, the selected and prepared advertisement content is displayed on a page of the search result.

This advertisement content is in the form of a banner advertisement and of value as an advertisement. However, it is of higher value when the user clicks on the content and the page of the sponsor site is consequently viewed by the user.

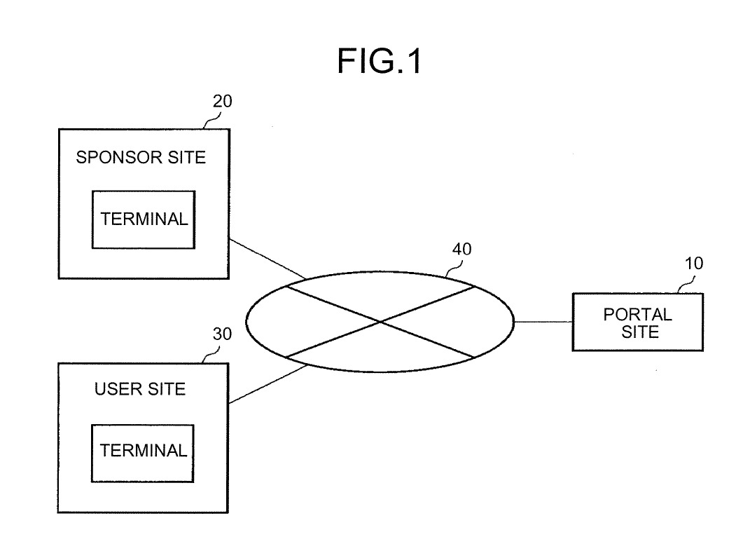

FIG. 1 is a block diagram of a basic configuration of a trend-creation-type advertising system according to a first embodiment of the present invention. In FIG. 1, the trend-creation-type advertising system includes a portal site 10, at least one sponsor site 20, and at least one user site 30. The respective sites are connected to one another by a network 40 such as the Internet.

The portal site 10 is a site that supports a trend creation advertisement with a selected buzzword candidate used as a push keyword.

Each sponsor site 20 carries out propaganda and advertises using the portal site. The sponsor site 20 includes a terminal that displays buzzword candidates managed by the portal site 10 and that casts votes in relation to the buzzword candidates.

Each user site 30 includes a terminal that transmits a request of an information search for acquiring desired information, that displays a search result, and that displays a Web page or the like. Terminals of the user sites 30 include not only those of users registered as users of the portal site 10 but those of users who temporarily access the portal site 10.

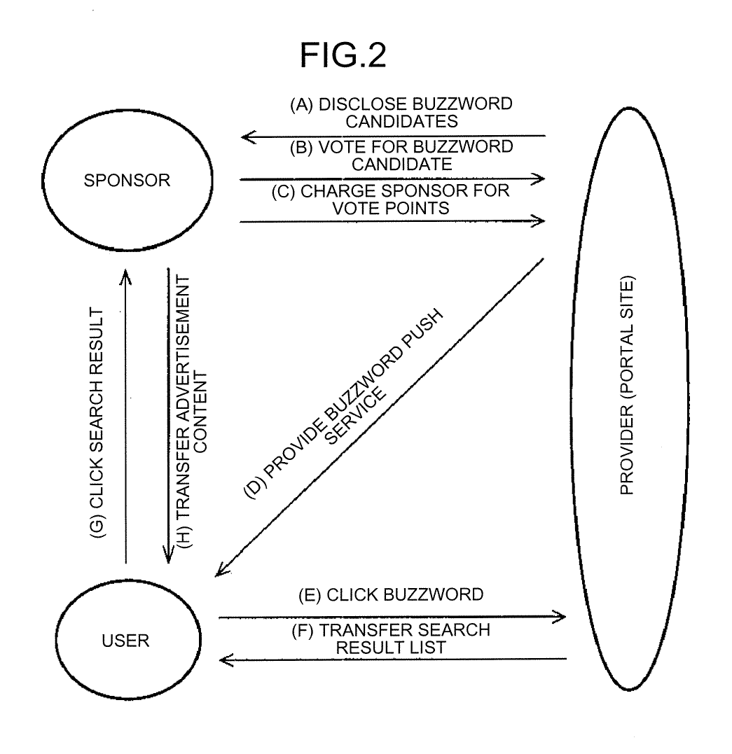

FIG. 2 is an explanatory view of roles of the respective sites in the trend-creation-type advertising system according to the first embodiment.

A provider manages buzzword candidates selected by trend analysts or the like and discloses the buzzword candidates to a sponsor (A). The sponsor decides vote points for a buzzword candidate associated with sponsor's business, and votes for the buzzword candidate, i.e., transmits the vote points (B). At this time, the sponsor pays a charge for the vote points (C).

The provider registers the vote points of each sponsor, and decides a buzzword based on a criterion according to the vote points.

If a user accesses the portal site of the provider, the provider transfers a portal page, to which a buzzword list is added, to the user (D). If the user clicks on the buzzword displayed on the portal site, a search request with the buzzword used as a keyword is transmitted to the portal site (E).

The portal site transfers a list of the search results based on the buzzword (keyword) to the user (F). An advertisement content registered by the sponsor, a URL of the sponsor page, and the like are added to this search result list.

If the user clicks on the advertisement content or the sponsor page in this search result list (G), the portal site 10 transfers the advertisement content or the sponsor page to the terminal of the user site 30 (H).

As can be seen, the sponsor creates the buzzword and induces the user to the sponsor site using this buzzword, whereby business chance expansion can be realized.

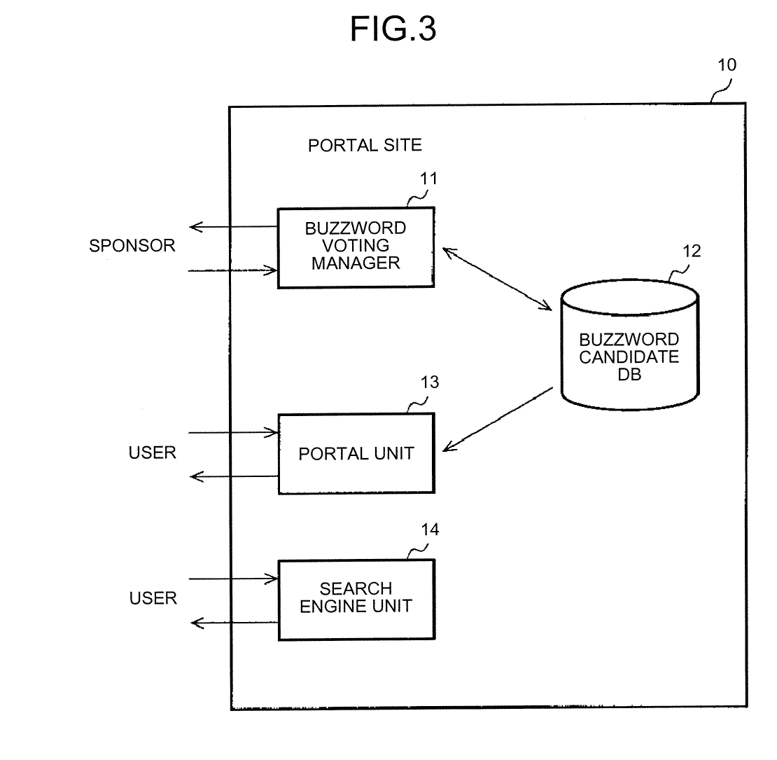

FIG. 3 is a block diagram of a functional configuration of the portal site according to the first embodiment. In FIG. 3, the portal site 10 includes at least a buzzword voting manager 11, a buzzword candidate database (DB) 12, a portal unit 13, and a search engine unit 14.

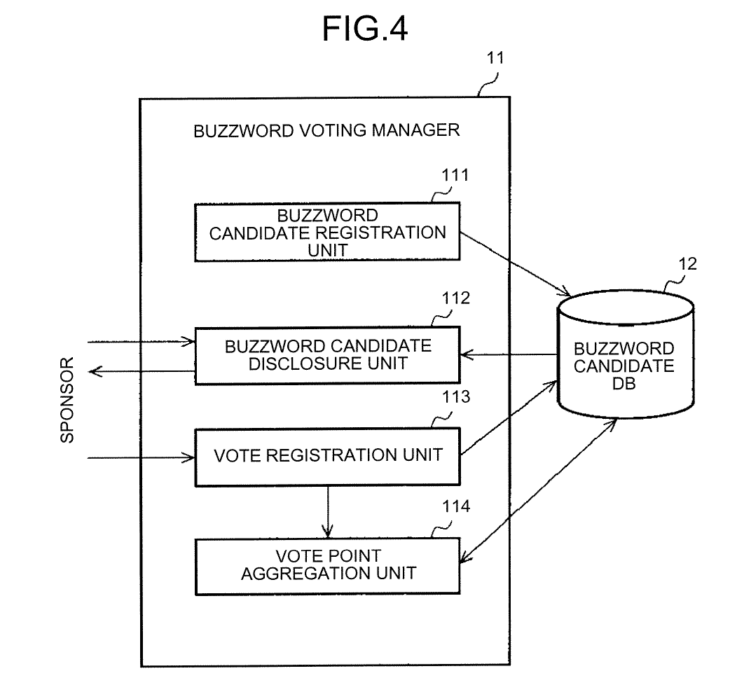

The buzzword voting manager 11 will first be explained. As shown in FIG. 4, the buzzword voting manager 11 includes a buzzword candidate registration unit 111, a buzzword candidate disclosure unit 112, a vote registration unit 113, a vote point aggregation unit 114, and the buzzword candidate DB 12.

A company (hereinafter, “provider”) that runs the portal site 10 analyzes questionnaires and various media contents by buzzword analysts or the like, and selects potentially buzzwords and keywords of potentially popular products as buzzword candidates.

The provider causes the buzzword candidate registration unit 111 to initially register the selected buzzword candidates in the buzzword candidate DB 12.

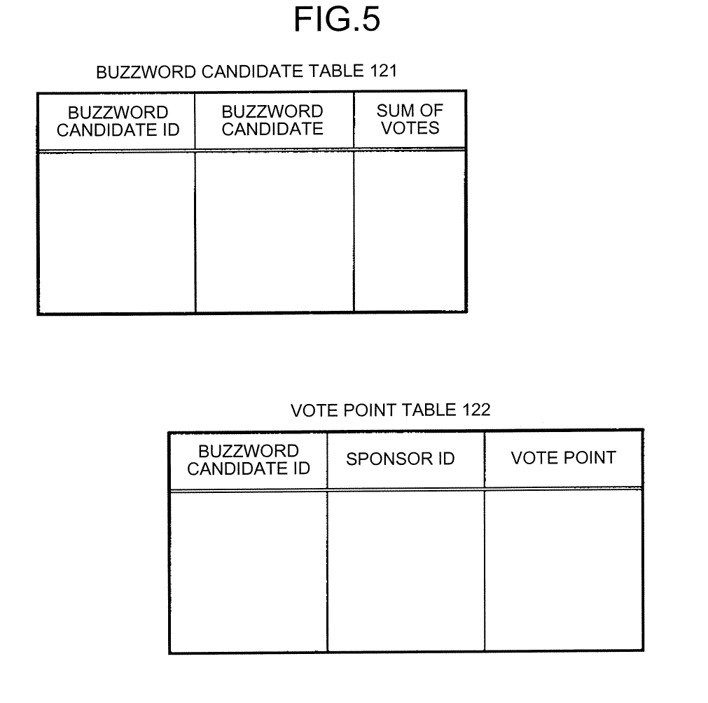

As shown in FIG. 5, the buzzword candidate DB 12 is constituted by a buzzword candidate table 121 and a vote point table 122, and stored in a storage device such as a hard disk device.

The buzzword candidate table 121 includes at least an identifier (ID) that identifies each buzzword candidate, a character string that represents each buzzword candidate, and a sum of vote points. In addition, the vote point table 122 includes each buzzword candidate ID, a sponsor ID, and vote points.

The buzzword candidate registration unit 111 allocates a uniquely set ID to each received buzzword candidate, stores the ID, the character string, and the sum of vote points of each buzzword candidate in the buzzword candidate table 121 with the sum of votes point set to zero. In an initial state, nothing is registered in the vote point table 122.

If the buzzword candidate is registered in the buzzword candidate DB 12, the provider generates a list of selected buzzword candidates and discloses the generated list. Examples of the disclosure method include a method for disclosing the list only to sponsors that cast votes and a method for disclosing the list to all users. If the latter method is used, a trend creation effect can be expected by disclosing a buzzword selection process to the users.

The sponsor to which the buzzword candidate list is disclosed accesses the buzzword voting manager 11 using the terminal of the sponsor site 20. At this time, the following functions are executed after the sponsor is authenticated on the Internet.

The buzzword voting manager 11 activates the buzzword candidate disclosure unit 112, generates a Web page for designating the buzzword candidate list and the vote points, and transmits the Web page to the sponsor site 20.

A purpose of voting is to create a trend not by competition among sponsors as seen in auctions but by cooperation of sponsors of same industries and different industries.

The sponsor selects at least one buzzword candidate from the buzzword candidate list in view of the purpose of voting and the viewpoint that if a company carries out propaganda and advertises using a buzzword, the buzzword has an effect on the sales of products and services of the company.

The sponsor inputs arbitrary vote points for the selected buzzword candidate and clicks on a vote button. Since the voting is a commercial behavior, the sponsor needs to pay a charge according to the vote points.

The sponsor can increase or decrease the vote points for the buzzword candidate which has been unnecessary for the advertisement or can cancel the vote only within a voting period.

If the sponsor casts a vote, then the portal site 10 activates the vote registration unit 113 to register a set of three items, i.e., the ID of the buzzword candidate for which the sponsor casts the vote, the ID of the sponsor that casts the vote, and the vote points of the sponsor in the vote point table 122.

If a new set of three items different only in vote points from an already registered set are transmitted, the vote registration unit 113 replaces the already registered set by the new set. In addition, if the sponsor transmits a request of deleting the buzzword candidate registered by the sponsor, the vote registration unit 113 deletes the set of three items including the ID of the buzzword candidate which is requested to be deleted and the sponsor ID from the vote point table 122.

The buzzword voting manager 11 activates the vote point aggregation unit 114 after the vote registration unit 113 finishes operating. The vote point aggregation unit 114 calculates a sum of vote points for every buzzword candidate registered in the vote point table 122, and updates the buzzword candidate table 121.

A timing of opening the sum of vote points thus aggregated is either a first timing at which the sum is disclosed to the sponsor when the voting period expires or a second timing at which the sum is disclosed to the sponsor at real time when the aggregation is finished.

If the sum is disclosed to the sponsor at the second timing, then the sponsor can cast a vote while observing a voting trend of the other sponsors and can cancel the vote within the voting period. Therefore, it is suitable for the trend creation advertising.

The provider discloses the aggregation result as well as the buzzword candidates and the vote points of the buzzword candidates in descending order of the number of obtained votes at an arbitrary time. Alternatively, the provider discloses the aggregation result and the like on the Web page for operating voting.

A predetermined number of buzzword candidates (e.g., top ten buzzword candidates) are selected as buzzwords according to the aggregated vote points.

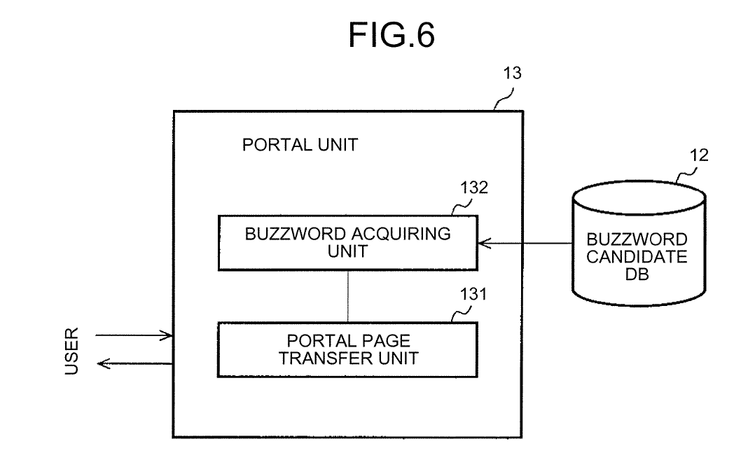

The portal unit 13 will next be explained. FIG. 6 is a block diagram of a functional configuration of the portal unit 13. In FIG. 6, the portal unit 13 includes a portal page transfer unit 131, a buzzword acquiring unit 132, and the buzzword candidate DB 12.

If the terminal of the user site 30 transmits a request to the portal unit 13, the portal unit 13 activates the portal page transfer unit 131.

The portal page transfer unit 131 activates the buzzword acquiring unit 132 to acquire a buzzword list. In addition, the portal page transfer unit 131 generates a hypertext content by adding sentences including the buzzword list or buzzwords to an ordinary portal Web page, and transfers the generated hypertext content to the terminal of the user site 30.

The user displays the portal Web page transferred from the portal site 10 using an existing browser or the like.

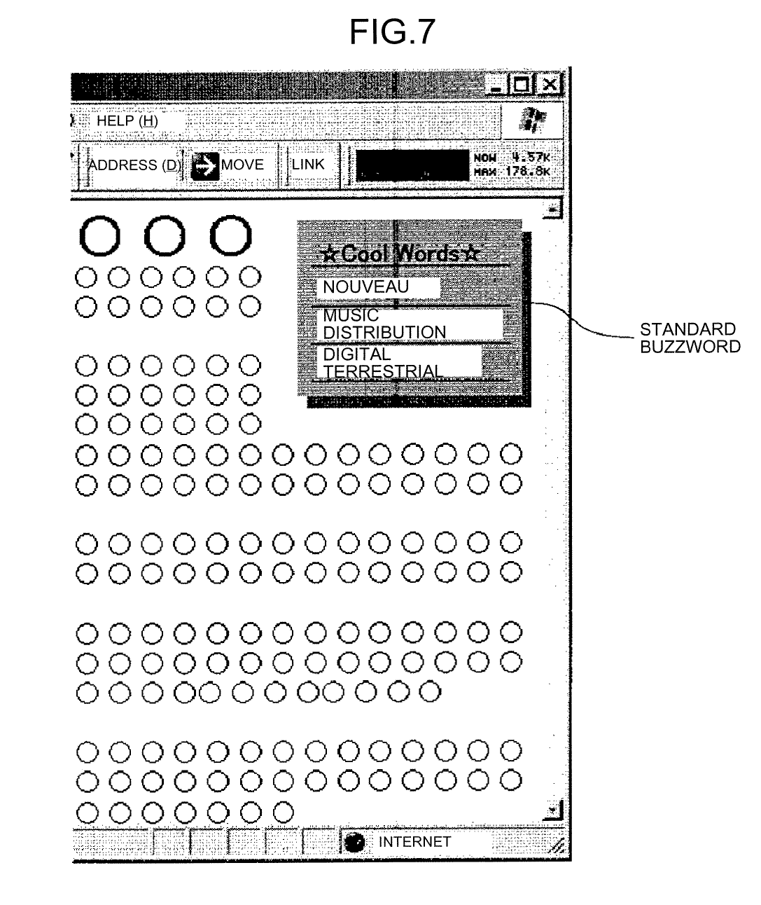

This buzzword list is displayed in a manner, for example, as shown in FIG. 7.

The buzzword acquiring unit 132 acquires the buzzword list by one of the following methods, and transmits the list to the terminal of the user site 30 that transmits the request.

In a first method, a vote rate of each buzzword candidate is calculated from the sum of votes registered in the buzzword candidate table 121, and a predetermined number of buzzword candidates (e.g., five candidates) are selected according to exposure ratios corresponding to the vote rates.

In a second method, fixed exposure ratios are set to correspond to the obtained votes such as 50% for a top candidate, 20% for a second top candidate, 10% for a third top candidate, and 5% for a fourth top candidate.

A predetermined number of (e.g., ten) buzzword candidates in descending order of the sum of obtained votes are selected. From among these ten candidates, five candidates are selected, for example, in descending order of exposure ratios. In this case, the candidates are displayed according not to the vote points but to the exposure ratios corresponding to ranks, so that competition among the sponsors is intensified.

If the user who views the portal Web page clicks on one of displayed buzzwords or one of the sentences including the buzzwords, the terminal of the user site 30 requests a search with the buzzword used as a keyword.

To request the search, one of the following three methods is used.

In a first method, the keyword is directly transmitted to the search engine unit 14.

In a second method, which is referred to as “redirect method”, the terminal of the user site 30 transfers the request to the portal unit 13, and the portal unit 13 requests the search engine unit 14 to do a search with the buzzword used as the keyword. This method enables the portal unit 13 to know which buzzword is clicked on.

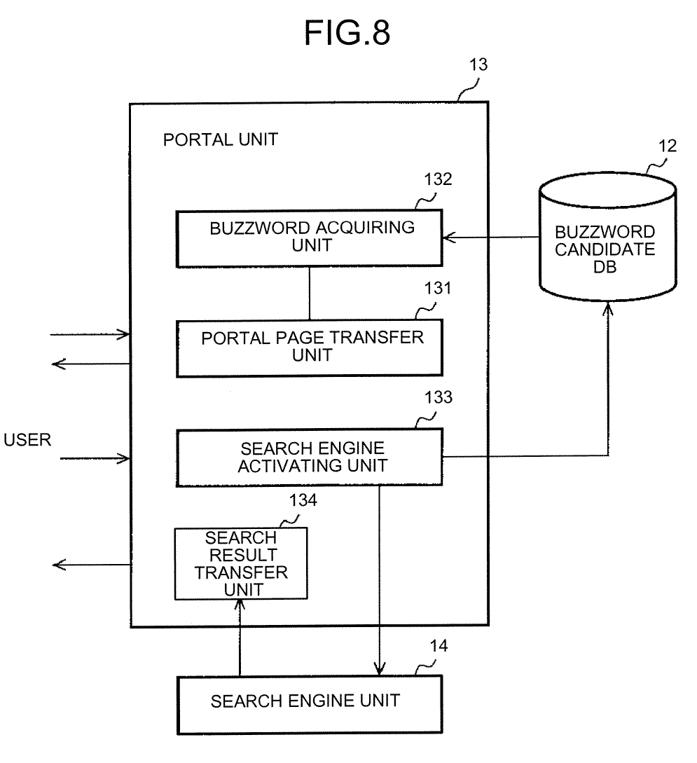

FIG. 8 is a block diagram of a functional configuration of the portal unit 13 if the portal unit 13 is used for this second method. The portal unit 13 includes the portal page transfer unit 131, the buzzword acquiring unit 132, a search engine activating unit 133, a search result transfer unit 134, and the buzzword candidate DB 12. The same functions as those shown in FIG. 6 will not be explained herein.

If the portal site 10 receives a search request with the buzzword used as the keyword from the terminal of the user site 30, the search engine activating unit 133 is activated. An item of a count of user's clicks is additionally prepared in the buzzword candidate table 121 in advance. The search engine activating unit 133 searches the buzzword candidate DB 12 for the received buzzword, and updates the count of user's clicks.

The search result transfer unit 134 transfers a search result from the search engine unit 14 to the terminal of the user site 30 that transmits the request.

In a third method, the portal unit 13 requests the search engine unit 14 to do a regular search with each buzzword used as a keyword. A content of search results with the respective buzzwords as keywords is prepared in advance. The prepared content is transferred to the terminal of the user site 30 whenever the terminal thereof transmits a request.

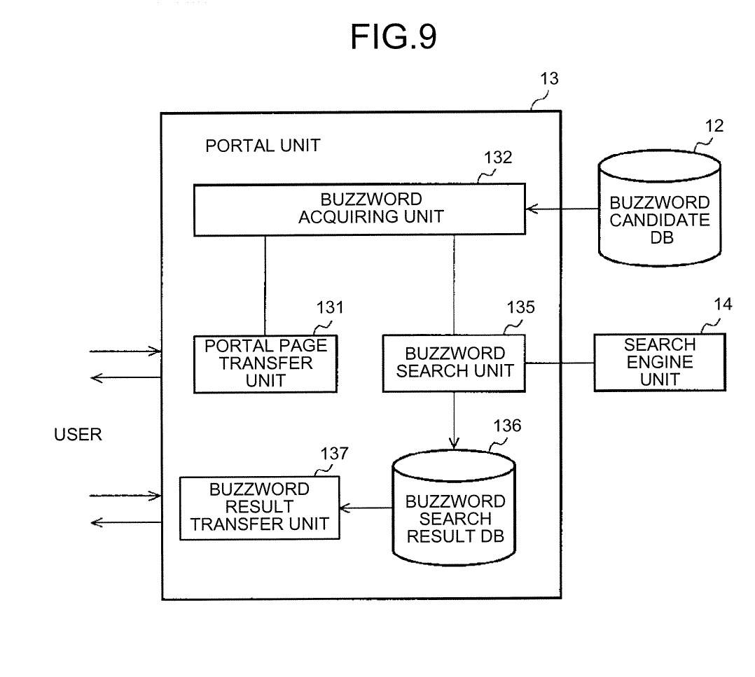

FIG. 9 is a block diagram of a functional configuration of the portal unit 13 if the portal unit 13 is used for this third search method. The portal unit 13 includes the portal page transfer unit 131, the buzzword acquiring unit 132, a buzzword search unit 135, a buzzword search result DB 136, a buzzword search result transfer unit 137, and the buzzword candidate DB 12. The same functions as those shown in FIG. 6 will not be explained herein.

The buzzword search unit 135 acquires a buzzword from the buzzword acquiring unit 132 on a regular (daily or weekly) basis. The buzzword search unit 135 transmits a search request with the acquired buzzword use as a keyword to the search engine unit 14, and stores a search result in the buzzword search result DB 136 while associating the search result with the buzzword (keyword).

If the portal site 10 receives a search request with a buzzword used as a keyword from the terminal of the user site 30, the buzzword search result transfer unit 137 is activated.

The buzzword search result transfer unit 137 searches the buzzword search result DB 136 for the buzzword for which the request is received, and a corresponding buzzword search result to the terminal of the user site 30 that transmits the request.

The search engine unit 14, which is equal in function to the conventional search engine, conducts a search with the buzzword transmitted from the portal unit 13 to the user as a keyword, and transfers a search result to the terminal of the user site 30 that transmits the request.

According to the first embodiment, the trend analysts or the like select the buzzword candidates. On the other hand, according to a second embodiment of the present invention, buzzword (potentially popular keyword) candidates are automatically acquired, and final buzzword candidates are selected from among these automatically acquired candidates and those proposed by the trend analysts or the like.

The portal site 10 according to the second embodiment is equal in configuration to that according to the first embodiment except for the buzzword voting manager 11.

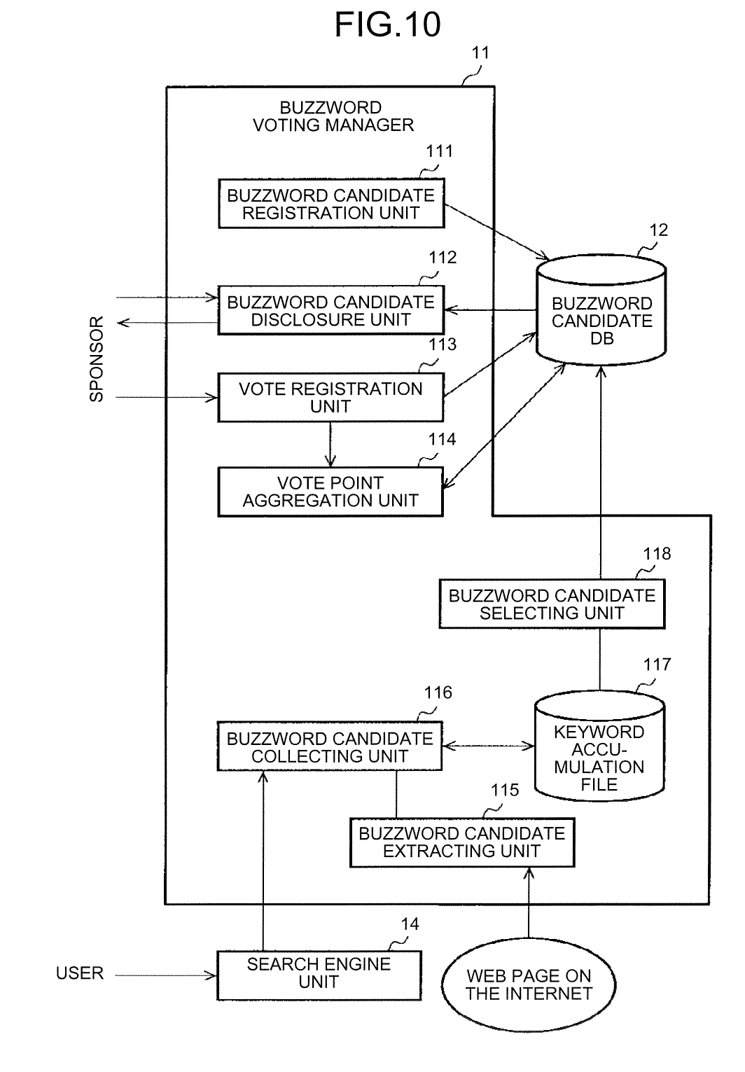

As shown in FIG. 10, the buzzword voting manager 11 according to the second embodiment includes the buzzword candidate registration unit 111, the buzzword candidate disclosure unit 112, the vote registration unit 113, the vote point aggregation unit 114, a buzzword candidate extracting unit 115, a buzzword candidate collecting unit 116, a keyword accumulation file 117, a buzzword candidate selecting unit 118, and the buzzword candidate DB 12. In FIG. 10, the same functions as those shown in FIG. 4 will not be explained herein.

As a method for acquiring buzzword candidates, one of the following two methods is used.

In a first method, buzzword candidates for which increments of the number of times of appearance of keywords searched by the search engine unit 14 are high, are acquired. Therefore, the candidates are acquired based on the users' positive behavior, i.e., the search and are preferable as the buzzword candidates.

If the terminal of the user site 30 directly transmits the search request to the search engine unit 14, the search engine unit 14 transmits the search keyword or buzzword for which the portal unit 13 receives the request, to the buzzword candidate collecting unit 116.

Alternatively, if the terminal of the user site 30 transmits the search request to the portal unit 13 by the redirect method, the portal unit 13 transmits the search keyword or buzzword for which the portal unit 13 receives the request, to the buzzword candidate collecting unit 116.

The buzzword candidate collecting unit 116 adds reception date information to the received keyword or buzzword, and accumulates the information-added keyword or buzzword in the keyword accumulation file 117 as log information.

In a second method, keywords having higher increments of the number of times of appearance are acquired from contents on the Internet. The keywords, i.e., buzzword candidates are often described in these contents. These contents are selected by narrowing down contents of forums, BBSs, blogs (diary-type simple individual websites) and the like which are users' information transmission means by appropriate sampling.

The buzzword candidate extracting unit 115 reads contents selected in advance on a certain time (e.g., daily) basis, and extracts keywords from the contents by morphological analysis. The buzzword candidate extracting unit 115 delivers the keywords left as a result of excluding unnecessary keywords to the buzzword candidate collecting unit 116.

The buzzword candidate selecting unit 118 analyzes the keyword log information accumulated in the keyword accumulation file 117 on a certain time (e.g., weekly, seasonal, semiannual, or annual) basis, and counts the number of times of appearance of each keyword on a plurality of certain time bases (e.g., on some of or all of daily, weekly, and monthly bases).

The aggregation of the number of times of appearance of each keyword is performed as follows. For the buzzword candidates, attention is paid to, for example, a specific product group. In this case, despite the same type of products, they are normally named different product names according to selling agents. Therefore, they are grouped and aggregated as one keyword. In addition, synonymous keywords are grouped and aggregated as one keyword.

Furthermore, for the buzzword candidates, even if the number of times of appearance of each keyword is large, the buzzword candidate, i.e., keyword is not necessarily a buzzword. For instance, if a certain candidate is a past buzzword, it is sometimes irrelevant to a present trend.

Accordingly, the increments of the numbers of times of appearance are compared on a plurality of time bases (on some of or all of daily, weekly, and monthly bases). In addition, the buzzword candidates are selected in descending order of the increment of the number of times of appearance on each time basis.

The buzzword candidate selecting unit 118 finally filters the buzzword candidates to exclude unnecessary keywords, and stores the selected buzzword candidates in the buzzword candidate DB 12 as buzzwords, similarly to the buzzword candidate registration unit 111.

Thereafter, an operation for allowing the trend analysts or the like to evaluate the candidates stored in the buzzword candidate DB 12 is performed.

According to the first and the second embodiments, the users or trend analysts decide the buzzword candidates, and the sponsor selects some of the candidates as buzzwords. The sponsor's positive intention is not reflected in the selection of the candidates.

According to a third embodiment of the present invention, the sponsor that is a voter proposes (recommends) buzzword candidates, adds arbitrary proposed points to each of the candidates, and registers the proposed candidates. If the number of buzzword candidates proposed by the sponsor is larger than the number of buzzwords to be disclosed, the candidates are selected in descending order of proposed points.

According to the third embodiment, the sponsor can register the buzzword candidates at a timing convenient for the sponsor without the need of awaiting appearance of the buzzword candidate suitable for the advertisement of the sponsor. The third embodiment differs from the preceding embodiments in that a trend can be created by calling to sponsors of the same industry and different industries for cooperation by proposing the buzzword candidates.

The portal site 10 according to the third embodiment is equal in configuration to that according to the first embodiment except for the buzzword voting manager 11.

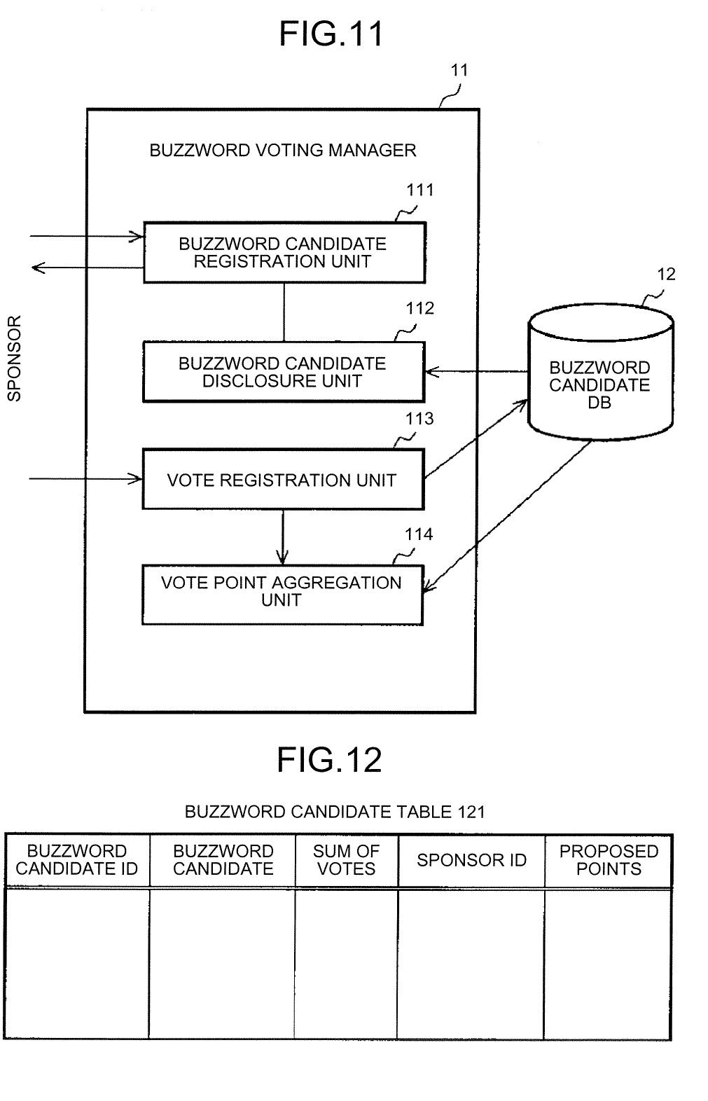

As shown in FIG. 11, the buzzword voting manager 11 includes the buzzword candidate registration unit 111, the buzzword candidate disclosure unit 112, the vote registration unit 113, the vote point aggregation unit 114, and the buzzword candidate DB 12. In FIG. 11, only the functions different from those shown in FIG. 4 will be explained.

If the terminal of the sponsor site 20 transmits a buzzword candidate registration request to the portal site 10, the buzzword candidate registration unit 111 is activated.

The buzzword candidate registration unit 111 generates a buzzword candidate registration Web page having a field to which the list of the buzzword candidates obtained from the buzzword candidate disclosure unit 112 and registered at present, new buzzword candidates, and proposed points of the new buzzword candidates can be input. The buzzword candidate registration unit 111 transmits the generated buzzword candidate registration Web page to the terminal of the sponsor site 20 that transmits the request. The field can be a plurality of fields.

The sponsor displays the buzzword candidate registration Web page transmitted from the portal site 10 using an existing browser or the like. After confirming that a buzzword candidate to be proposed by the sponsor is not present on the displayed buzzword candidate list, the sponsor inputs at least one set of the buzzword candidate to be proposed and proposed points of the candidate to the field, and executes registration of the candidate.

The vote registration unit 113 receives execution of the registration from the terminal of the sponsor site 20, allocates a uniquely set ID to the buzzword candidate for which vote registration unit 113 receives the execution of the registration, and stores an ID of the sponsor that proposes the candidate and the proposed points in the buzzword candidate table 121.

As shown in FIG. 12, the buzzword candidate table 121 includes data items of sponsor ID and proposed points in addition to those shown in FIG. 5.

According to the first to the third embodiments, the vote for the buzzword candidate is cast in the period set by the provider. However, since about when which buzzword candidate becomes a buzzword has an effect on an advertising strategy and a service sales strategy of the sponsor, the sponsor desires to concentrate an investment on a certain period.

Based on this, according to a fourth embodiment of the present invention, a buzzword voting period is divided into a plurality of periods, a date and vote points are designated within each divided voting period, and the sponsor is charged for the designated vote points.

The portal site 10 according to the fourth embodiment is equal in configuration to those according to the first to the third embodiments except for the function of the buzzword voting manager 11. This difference will only be explained herein.

If the portal site 10 receives a buzzword candidate display request from the sponsor site 20 when the sponsor votes for a buzzword candidate, the buzzword candidate disclosure unit 112 is activated.

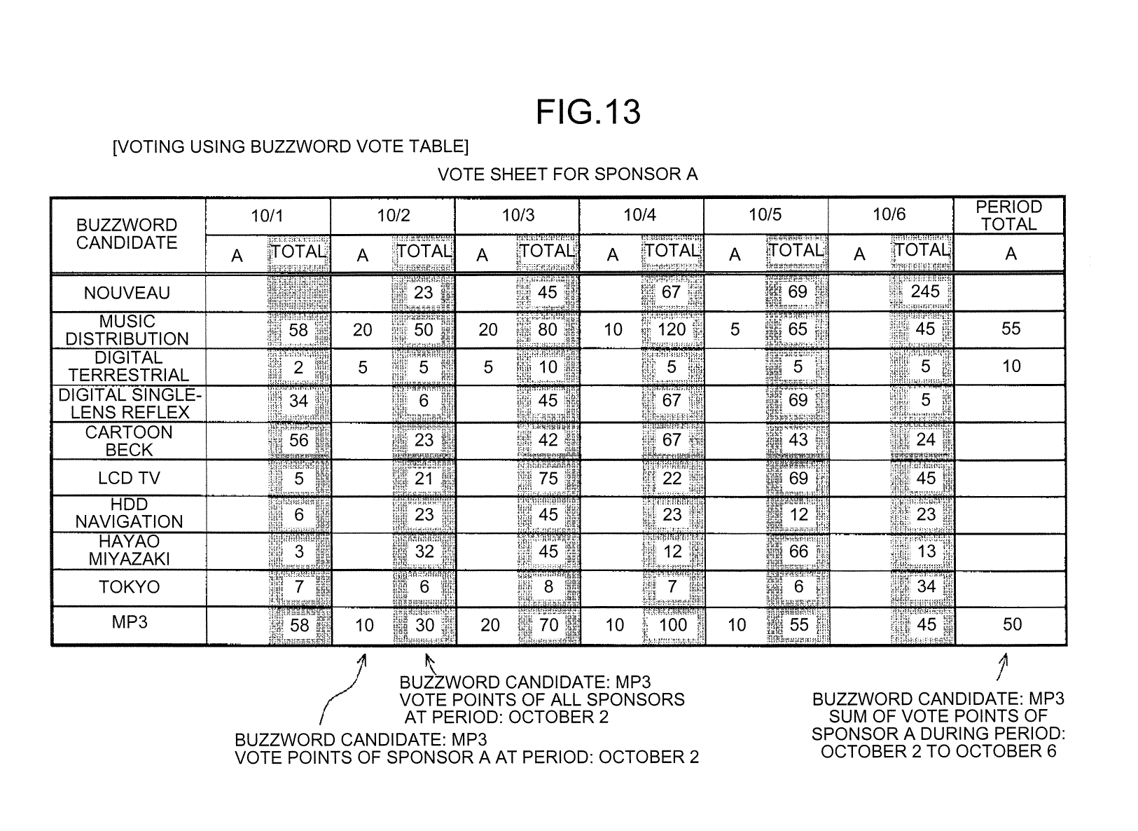

At the time of disclosing the buzzword candidate list, the buzzword candidate disclosure unit 112 generates a Web page in a table form of a matrix of buzzword candidates and voting periods as shown in, for example, FIG. 13. In addition, the buzzword candidate disclosure unit 112 transmits the generated Web page to the sponsor site 20.

In FIG. 13, the vertical axis indicates a list of buzzword candidates and the horizontal axis indicates voting periods on a daily basis. For one day of each buzzword candidate, vote points by which each sponsor votes for the buzzword candidate and a sum of vote points including those of the other sponsors are separately displayed on the table. In addition, total vote points of each sponsor in the entire voting period are displayed on a right end of the table for every buzzword candidate.

These display boxes of the vote points of each sponsor on a daily basis serve as both display boxes and correction boxes.

For example, it is understood from the table shown in FIG. 13 that vote points on October 2 for the buzzword candidate “MP3” are ten points of a sponsor A and 30 points of entire sponsors. In addition, total vote points of the sponsor A in the entire voting period for the buzzword candidate “MP3” are 50 points.

If the sponsor casts a vote on the sponsor site 20, then the vote registration unit 113 is activated to register a set of four items, i.e., the ID of the buzzword candidate for which the sponsor transmits a request, a voting date of the sponsor, the sponsor ID, and the vote points of the sponsor, in the vote point table 122 on the portal site 10.

According to the fourth embodiment, each buzzword candidate is decided by many and unspecified users or sponsors.

However, in a state in which buzzwords are not classified, many sponsors tend to constantly select relevant buzzword candidates. To avoid this tendency, the buzzwords are classified according to categories so that each sponsor can vote for a buzzword candidate displayed on a category basis.

By doing so, this tendency can be avoided, and the sponsor can concentrate the investment on the buzzword candidates in the category suitable for the advertising strategy and service sales strategy of the sponsor.

To classify buzzwords, one of the following two methods is used.

In a first classification method, the buzzwords are classified into buzzwords for many and unspecified users and those for a specific user group. In a second classification method, the latter buzzwords by the first method are further classified into those for respective user groups. Examples of buzzwords classified by the first method include season-dependent “seasonal buzzwords”, universal “ordinary buzzwords”, and “niche buzzwords” for the specific user group. The “niche buzzwords” can be classified in various manners. Example of them include “cartoon”.

According to the fourth embodiment, when the trend analysts select buzzword candidates, they select potential buzzwords or keywords of potentially popular products according to the respective categories. The selected phrases or keywords are stored in the buzzword candidate table 121. The data items stored in the buzzword candidate table 121 include at least the ID for identifying each buzzword candidate, the character string representing the buzzword candidate, the category, and sum of vote points.

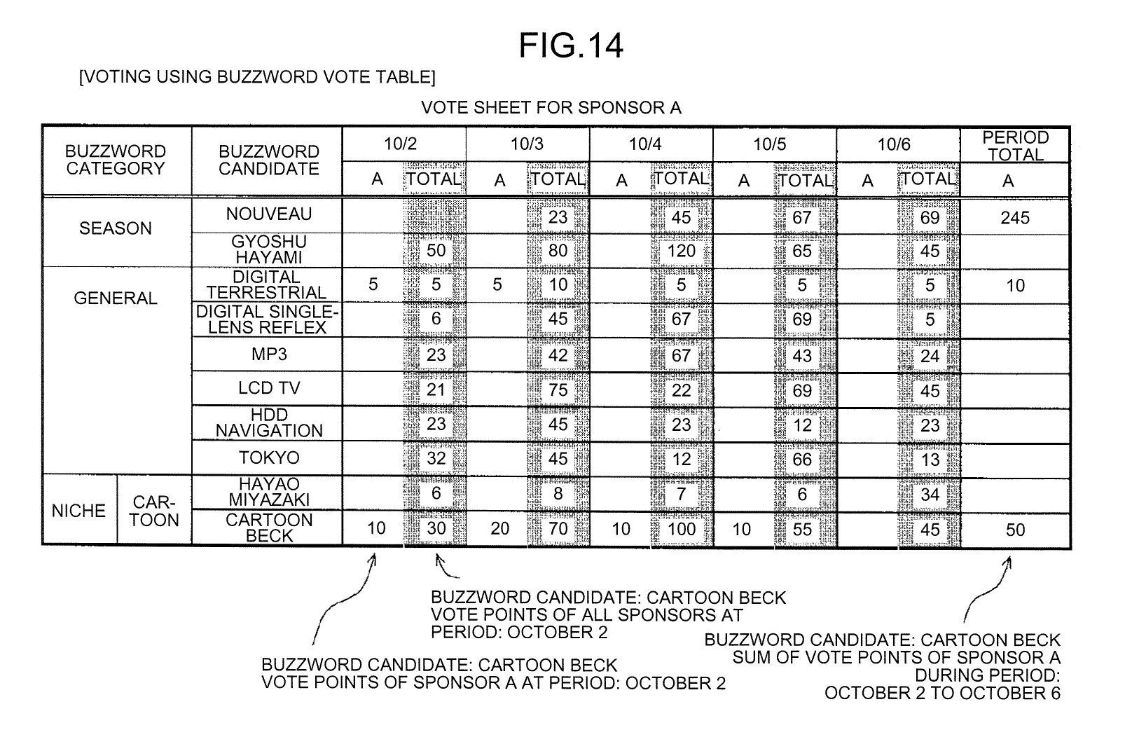

To disclose the buzzword candidate list, the buzzword candidate disclosure unit 112 discloses the respective buzzword candidates shown in FIG. 13 according to categories as shown in FIG. 14.

With reference to FIG. 14, the categories of the buzzwords are “season”, “general”, and “niche”. The category “niche” is further classified into the specific category “cartoon”. In FIG. 14, the buzzword candidates belonging to these categories are displayed in order.

According to the first to the fourth embodiments, the buzzwords displayed when the user accesses the portal unit 13 are normally prepared buzzwords irrespective of user's preference.

According to a fifth embodiment of the present invention, personalized buzzwords based on user's preference are displayed when the user accesses the portal unit 13.

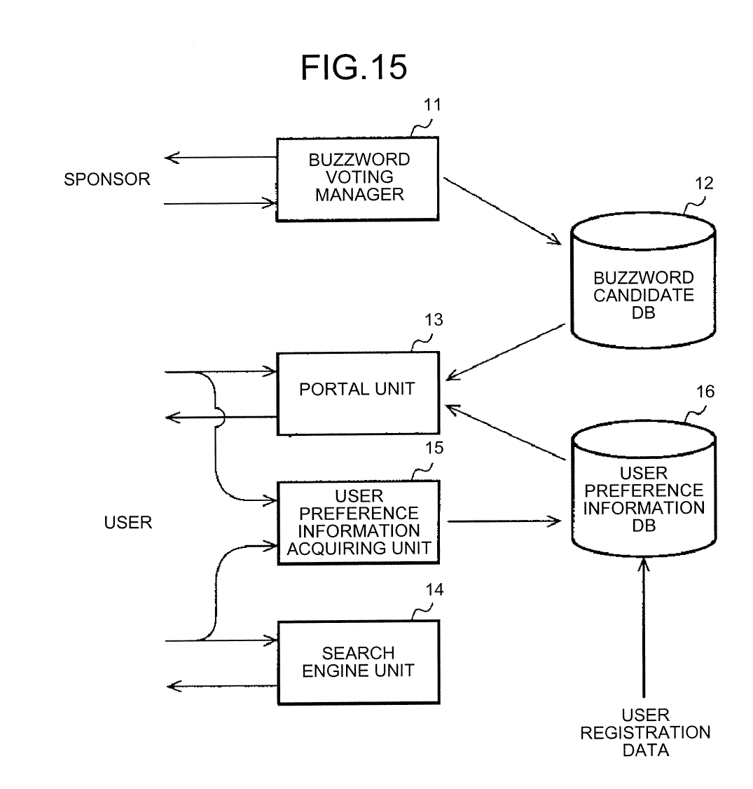

As shown in FIG. 15, a trend-creation-type advertising system according to the fifth embodiment includes the buzzword voting manager 11, the buzzword candidate DB 12, the portal unit 13, a user preference information acquiring unit 15, and a user preference information DB 16. The same functions as those explained in the first to the fourth embodiments will not be explained, and only the different functions will be explained herein.

The user preference information acquiring unit 15 and the user preference information DB 16 will be explained.

To acquire user preference information, one of the following three methods is used.

In a first acquisition method, each user registers user preference information.

In this method, the user often registers, as user meta data, user's name, sex, age, occupation, hobby, and the like so as to receive some information service from the provider that provides the portal unit 13. At this moment, information useful to identify the user, e.g., an IP address, a hobby, and the like of the user are registered in the user preference information DB 16.

In a second acquisition method, the user preference information is acquired by user's input operation.

The user preference information is acquired by user's operation for inputting a keyword for a search, for inputting a content transfer request (by a click or the like while the user is viewing a website) to the portal unit 13. The acquired user preference information is registered, as the user preference information, in the user preference information DB 16.

In a third acquisition method, a user is not specified in advance. It is confirmed that a user is the same as a certain user only while the user starts viewing the portal unit 13 and stops viewing it. The user preference information is acquired from the user's content transfer request (by operation of button clicking or the like) until the user clicks on a buzzword, and the acquired user preference information is registered in the user preference information DB 16.

The portal unit 13 records the IP address of the user and a URL for which the user transmits the request, which are transferred from the terminal of the user site 30 whenever the user clicks on the button in a storage device while the user views a plurality of contents after transmitting a first transfer request. However, if the user's request is interrupted for a certain period of time, this recorded IP address can be deleted.

A content-keyword table in which a keyword (or a plurality of keywords) characterizing each content stored in the portal unit 13 in advance is made correspond to a URL of the content is prepared. This keyword is assumed to be one that indicates what a user is interested in.

Alternatively, this content-keyword table can be replaced by phrases or the like of buttons clicked on when the user transmits the content transfer request.

Whenever the user request one of the contents held in the portal unit 13 (by operation of button clicking or the like), the portal unit 13 refers to the content-keyword table, extracts a keyword corresponding to the URL of the content, records the keyword in the user preference information DB 16 while making the keyword correspond to the user who clicks on the button.

If the user then accesses the portal unit 13 based on the user preference information thus generated, the personalized buzzwords based on the user's preference are displayed. The difference of the fifth embodiment from the preceding first to fourth embodiments in relation to the portal unit is that the buzzword list obtained from the buzzword acquiring unit 132 and the buzzword list obtained from the portal page transfer unit 131 are displayed.

To display the personalized buzzwords, one of the following two methods is used.

In a first display method, displayed buzzwords are all selected based on the user preference information. This first method is suitable for combination with the acquisition method with the user preference information fixed such as the first acquisition method.

In a second display method, a common buzzword display area and a personalized buzzword display area are provided, and personalized buzzwords are displayed according to acquisition of the user preference information. This second method is suitable for a combination with the acquisition method with the user' preference information changed (added) such as the third acquisition method.

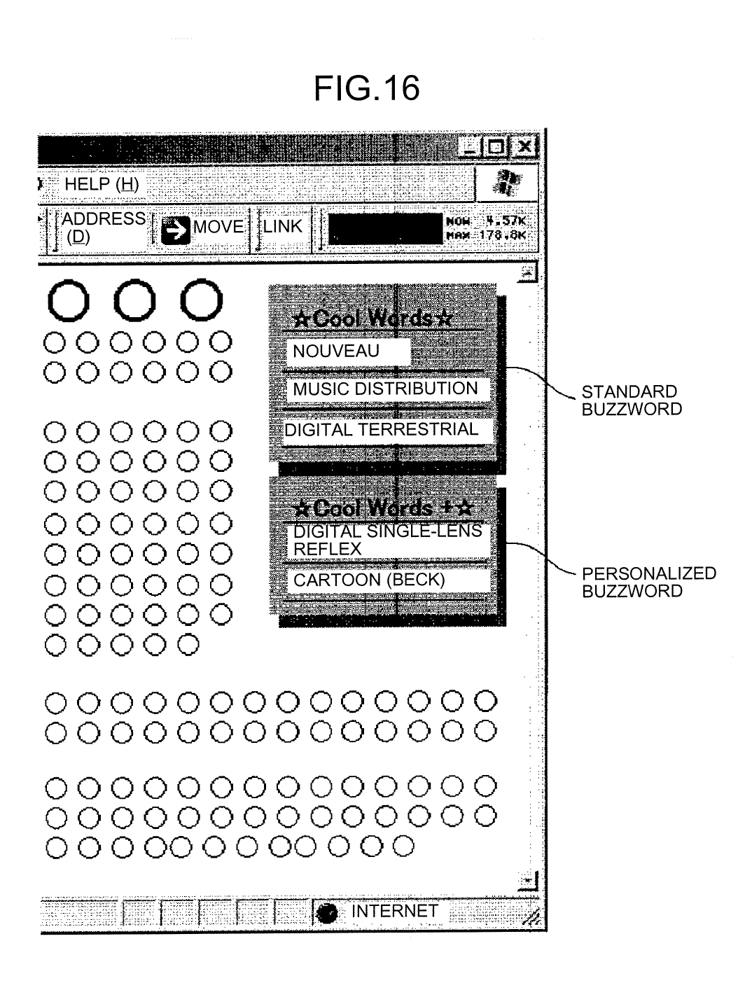

As shown in FIG. 16, for example, for buzzwords, a list of “standard buzzwords” and a list of “personalized buzzwords” in which the user appears to be interested are displayed.

To obtain the personalized buzzword list, the buzzword acquiring unit 132 performs the following processing.

The buzzword acquiring unit 132 classifies phrases (keywords), and generates a phrase classification table in which the respective keywords are made correspond to class cords corresponding to categories of the keywords. Referring to the phrase classification table, the buzzword acquiring unit 132 does a search as to which keyword a previously acquired buzzword corresponds, and acquires the class cord corresponding to the keyword on the phrase classification table.

Furthermore, referring to the phrase classification table, the buzzword acquiring unit 132 acquires class cords corresponding to the keywords recorded in the user preference information DB 16.

The buzzword acquiring unit 132 selects buzzwords having the same buzzword class cords as those corresponding to the user preference information to define the selected buzzwords as personalized buzzwords. In addition, the buzzword acquiring unit 132 selects buzzwords to be displayed at exposure ratios corresponding to the obtained votes from among these personalized buzzwords.

The portal page transfer unit 131 generates, from the content generated by the portal unit 13, a hypertext content in which the personalized buzzword list or the sentences including the personalized buzzwords are described in a personalized buzzword display area. The portal page transfer unit 131 transfers the generated hypertext content to the terminal of the user site 30.

Whenever the user accesses the portal site 10, the user's preference is analyzed, the personalized buzzwords are updated to new ones, and the new personalized buzzwords are displayed.

The Internet trend is largely attributed to the word of mouth effect produced by users. Due to this, it is effective to display the count of users' clicks on buzzwords together with each buzzword as a mechanism for transmitting one user's reaction to the other users. It appears to be also effective to increase the exposure ratio of the buzzword on which users click many times or to place the buzzword at a higher display rank.

According to a sixth embodiment of the present invention, the buzzword list according to the first to the fifth embodiments is displayed so that the count of clicks by each user is adjacent to a buzzword.

To this end, the portal page transfer unit 131 of the portal unit 13 embeds a counter for displaying the count of clicks on each buzzword by each user in the buzzword when generating the portal site Web page, and transfers the Web page to the user.

If a user clicks on a buzzword, information as to which buzzword the user clicks on is transmitted to the portal unit 13. Before searching the buzzword, the portal unit 13 aggregates the count of clicks on the corresponding buzzword in the buzzword candidate table 121 and updates the buzzword candidate table 121. The buzzword candidate table 121 used herein includes a data item of storing the count of clicks on each buzzword candidate.

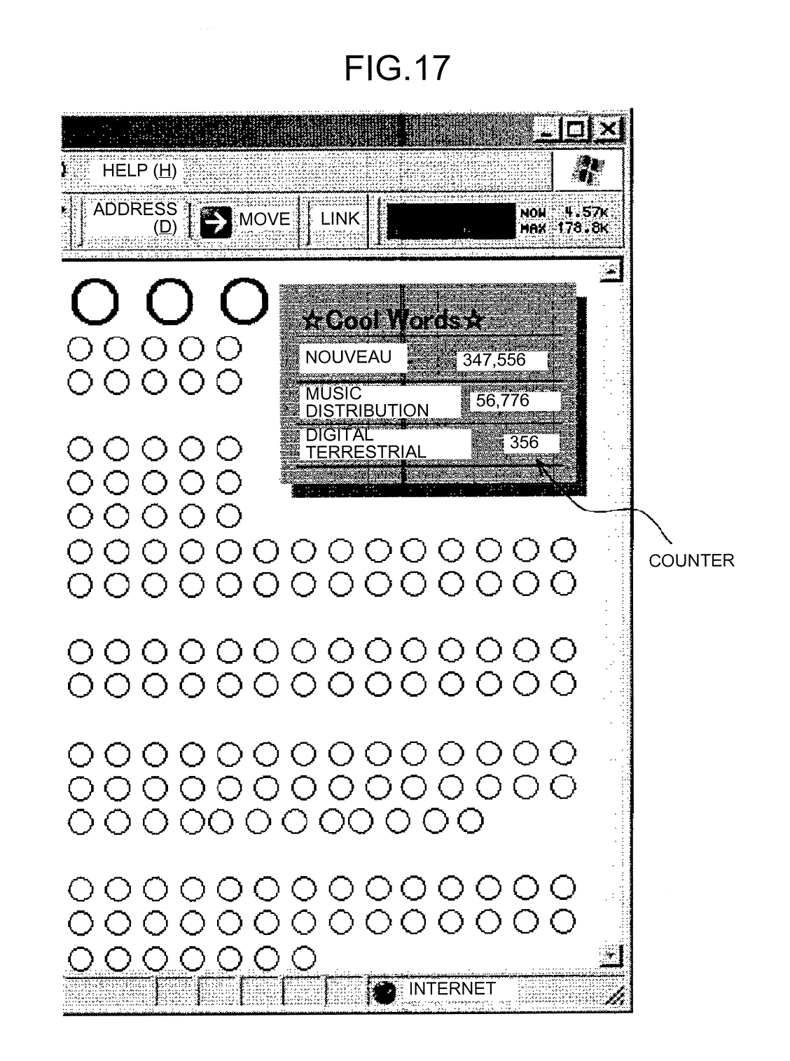

If the user accesses the portal site 13 next time, the portal page transfer unit 131 displays the count of clicks adjacent to the buzzword as shown in FIG. 17.

At this time, it is possible to increase the exposure ratio of the buzzword having the high count of clicks or to change the display rank of the buzzword as explained above. However, this may possibly cause the sponsors to click on intended buzzwords many times. This can result in deterioration of the commercial value of charged votes for buzzword candidates.

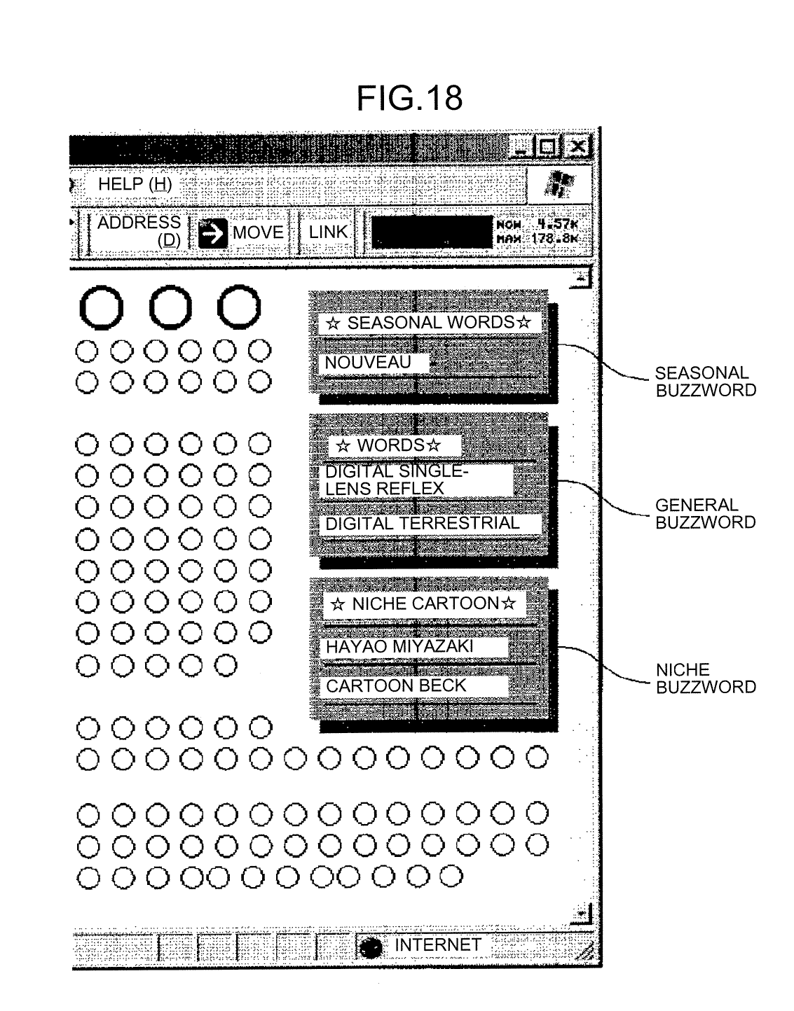

Furthermore, if the buzzwords are classified according to categories and the user preference information can be acquired, appropriate buzzwords according to the user's preference can be displayed as shown in FIG. 18.

If the buzzwords are not classified, unpredictable buzzwords are displayed less frequently and the user's interest lowers. If the buzzwords are classified, buzzwords even with low vote points but relevant to a season or an event in the season are displayed as, for example, “seasonal buzzwords”. In addition, as “niche buzzwords”, buzzwords that interest specific users are displayed.

If a search is conducted with a buzzword used as a keyword, that is, a search is conducted using one keyword, much unnecessary information are often searched.

According to a seventh embodiment of the present invention, an appropriate auxiliary keyword is selected by an evaluator of the portal site 10, and made correspond to each buzzword. If the user requests a search with a buzzword, the buzzword and the auxiliary keyword corresponding to the buzzword are searched.

The portal site 10 according to the seventh embodiment is equal in configuration to those according to the first to the sixth embodiments except for the functions of the buzzword voting manager 11, the portal unit 13, and the search engine unit 14. These differences will only be explained herein.

After selection of buzzword candidates, the evaluator of the provider selects an appropriate auxiliary keyword.

The buzzword voting manager 11 causes the buzzword candidate registration unit 111 to register buzzword candidates and an auxiliary keyword (or a plurality of auxiliary keywords) in the buzzword candidate DB 12.

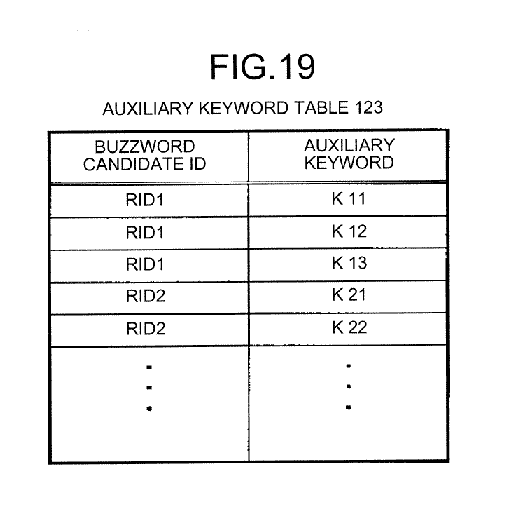

The buzzword candidate DB 12 further includes an auxiliary keyword table 123 that stores buzzword candidates and auxiliary keywords while making the auxiliary keyword(s) correspond to each buzzword candidate. A set of two items, the buzzword candidate ID and the auxiliary keyword are stored in this auxiliary keyword table 123. If a plurality of auxiliary keywords are present to correspond to one buzzword candidate, as many sets of the buzzword candidate ID and auxiliary keywords as the different auxiliary keywords are stored for every buzzword candidate in the table 123 (see FIG. 19).

If the sponsor transmits a buzzword candidate disclosure request to the portal site 10, the buzzword candidate disclosure unit 112 discloses the selected buzzword candidates and auxiliary keywords.

If only the buzzwords are disclosed, the sponsor is unable to determine whether the content of the sponsor is disclosed. It is, therefore, preferable to generate a list of the selected buzzword candidates and auxiliary keywords, and to disclose the generated list on the Internet. By viewing this list, the sponsor can predict a probability that the content of the sponsor is displayed as a result of a search, and evaluate whether each buzzword candidate is of advertising value for the sponsor.

According to the seventh embodiment, the provider provides the auxiliary keyword of each buzzword for a narrowing-down search, i.e., noise elimination. On the other hand, according to an eighth embodiment of the present invention, a trend is created by cooperation of sponsors.

According to the eighth embodiment, an advertisement content of each sponsor is prepared, and a sponsor keyword is provided by the sponsor so that this advertisement ranks high on a search result list. As this sponsor keyword, a cooperate name of the sponsor, a product name, an event name or the like is used. The sponsor keyword is arbitrarily applied for and registered by the sponsor. By doing so, the portal site serves as a cooperation field and a competition field among sponsors.

The portal site 10 according to the eighth embodiment is equal in configuration to those according to the first to the seventh embodiments except for the functions of the buzzword voting manager 11 and the portal unit 13. These differences will only be explained herein.

The buzzword candidate disclosure unit 112 of the buzzword voting manager 11 generates a Web page on which the buzzword candidate list and one or more sponsor keywords for the buzzword candidate from this list can be input. In addition, the buzzword candidate disclosure unit 112 discloses the generated Web page to the sponsor. Vote points for the sponsor keyword can be included in the sponsor keyword.

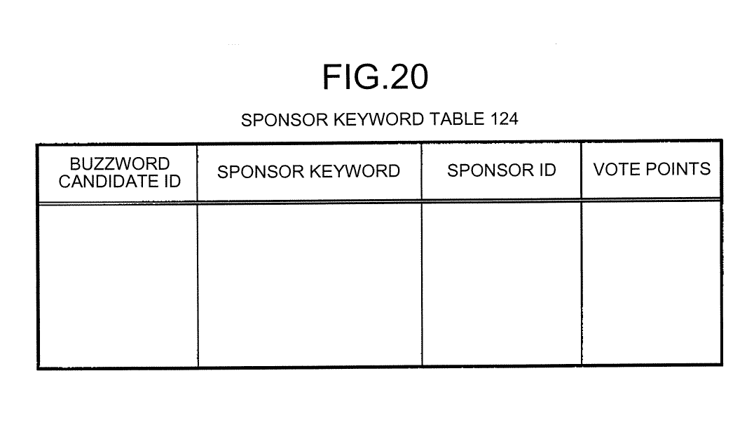

If the sponsor transmits a vote for the sponsor keyword to the portal site 10, the vote registration unit 113 stores the transmitted sponsor keyword and vote points in a sponsor keyword table 124 of the buzzword candidate DB 12. As shown in FIG. 20, the sponsor keyword table 124 stores a set of four data items of the buzzword candidate ID, the sponsor keyword, the ID of the sponsor as voter, and the vote points for this sponsor keyword.

Thereafter, the vote registration unit 113 aggregates the vote points for the sponsor keyword corresponding to one buzzword candidate, and adds the points to the vote points for the buzzword in the buzzword candidate table 121.

According to the preceding embodiments, vote points are input for each buzzword candidate. According to the eighth embodiment, by contrast, a sum of vote points input for the sponsor keyword serves as vote points for the buzzword candidate.

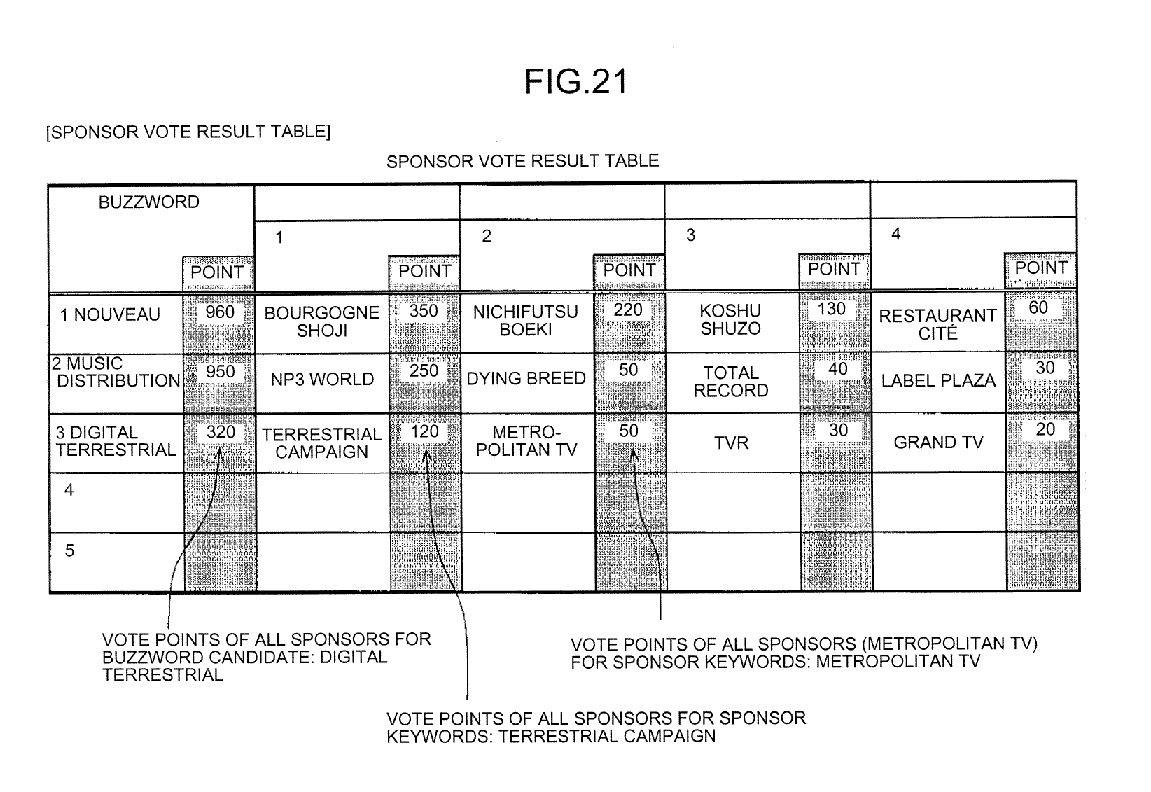

FIG. 21 is an example of a result of sponsor's casting a vote for each buzzword candidate using the sponsor keyword. In FIG. 21, buzzwords are listed and total vote points for each buzzword are displayed in a vertical direction. Sponsor keywords corresponding to each buzzword are listed and a sum of vote points of all sponsors for each sponsor keyword is displayed in a horizontal direction.

For example, a sum of vote points of all sponsors for a third top buzzword “DIGITAL TERRESTRIAL” is 320 points. A sum of vote points of all sponsors for a top sponsor keyword “GROUND WAVE CAMPAIGN” added to the buzzword “DIGITAL TERRESTRIAL” is 120 points. Since this sponsor keyword “GROUND WAVE CAMPAIGN” is for a joint event held by a plurality of sponsors, the vote points are high.

However, a sum of vote points of all sponsors for a second top sponsor keyword “METROPOLITAN TV” is as low as 50 points. This is because the METROPOLITAN TV is a single sponsor.

The buzzword acquiring unit 132 selects buzzwords according to obtained votes and exposure ratios similarly to the preceding embodiments. The buzzword acquiring unit 132 selects a predetermined number of (e.g., four) buzzwords according to the exposure ratios corresponding to the vote points for sponsor keywords from among the sponsor keywords added to the selected buzzword s and registered.

Alternatively, certain exposure ratios can be set to correspond to vote point ranks (e.g., 50% for top sponsor keyword, 20% for second top, 10% for third top, and 5% for fourth top). The buzzword acquiring unit 132 selects, for example, four buzzwords to correspond to the exposure ratios. In the latter case, the buzzwords are displayed according not to the vote points but to the exposure ratios corresponding to ranks, so that competition among the sponsors is intensified.

Furthermore, differently from the preceding embodiments, the portal unit 13 searches a buzzword as well as sponsor keywords corresponding to the buzzword when the user clicks on the buzzword.

According to a ninth embodiment of the present invention, the sponsor is charged for a sponsor's behavior of voting for a buzzword according to the first to the eighth embodiments. Vote points represent a voting right of the sponsor and the sponsor can cast a vote on a one-point basis. To charge the sponsor for the vote points, one of the following charging methods is used.

In a first method, vote points are marketed. In a second method, vote points of a sponsor are aggregated and the sponsor is charged for vote points on a certain period basis (e.g., on a monthly basis). The first method is suitable for an instance in which vote points are marketed at low price. The second method is suitable for an instance in which vote points are marketed at high price. Needless to say, vote points can be marketed based on a combination of the first and the second methods.

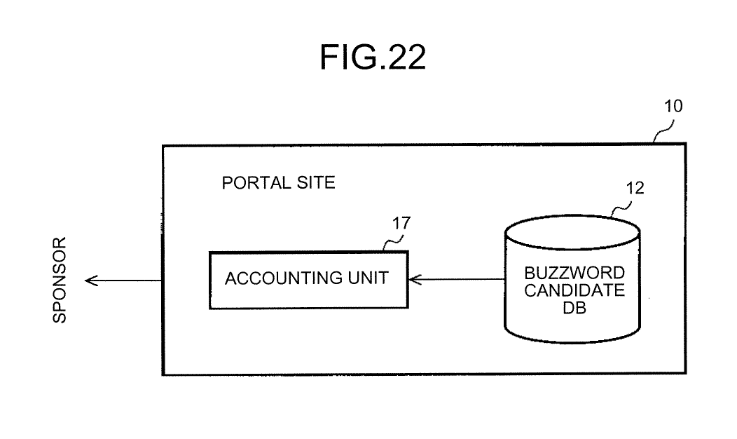

A trend-creation-type advertising system according to the ninth embodiment differs in configuration from those according to the first to the eighth embodiments in that the portal site 10 includes an accounting unit 17. In FIG. 22, only a charging-related configuration is shown while the same constituent elements as those according to the first to the eighth embodiments are not shown.

The accounting unit 17 calculates a monthly sum of vote points in the following three tables for every sponsor ID.

(1) A sum of vote points of the same sponsor ID is calculated in the buzzword candidate table 121.

(2) If buzzword candidates recommended by the sponsor itself are provided, a sum of vote points of the same sponsor ID is calculated in the buzzword candidate table 121.

(3) If sponsor keywords are provided, a sum of vote points of the same sponsor ID is calculated in the sponsor keyword table 124.

The accounting unit 17 converts the monthly sum of vote points of every sponsor into an amount of money and charges each sponsor for the vote points. Thereafter, the accounting unit 17 confirms whether the charge is paid.

To create a trend, it is preferable that a plurality of sponsors concentrate on voting for a specific buzzword candidate. To realize this, according to a tenth embodiment of the present invention, a point unit price for a buzzword for which high vote points are obtained is discounted.

The discounted point unit price is disclosed by adding a point unit price to the buzzword candidate at that point. If the relationship between the obtained votes and the discounted point unit price is disclosed to the sponsor, the disclosure of the discounted point unit price can be replaced by that of the obtained votes.

Since a trend-creation-type advertising system according to the tenth embodiment is equal in configuration to the ninth embodiment, differences from the ninth embodiment will only be explained.

To disclose the buzzword candidate list to the sponsor, the buzzword candidate disclosure unit 112 discloses it as a list in which a point unit price is added to each buzzword candidate. On the first occasion, an initial value of the point unit price, i.e., non-discounted point unit price is disclosed to the sponsor. On the second and the following occasions, a point unit price recalculated according to vote points is disclosed thereto.

If the sponsor casts a vote for a buzzword candidate, then the vote point aggregation unit 114 recalculates the point unit price for every buzzword candidate based on a sum of vote points for the buzzword candidate, and stores the recalculated point unit price while making it correspond to the buzzword candidate in the buzzword candidate table 121. This aggregation is carried out repeatedly while the sponsors are casting votes. The point unit price is higher if the vote points are higher.

According to the present invention, even if a user clicks on a buzzword, it is not ensured that a sponsor content is disclosed to the user. Nevertheless, it is preferable for each sponsor to charge the user for user's click on the buzzword rather than to charge the user for exposure of the buzzword so as to evaluate an advertising effect.

A trend-creation-type advertising system according to an eleventh embodiment is equal in configuration to that according to the ninth embodiment except that a user is charged based on a unit price according to the count of user's clicks.

If the user requests display of a portal page and clicks on a buzzword on the displayed portal page, the portal unit 13 is requested to do a search with the buzzword used as a keyword.

The portal unit 13 counts clicks for every transmitted buzzword in response to the user's search request, and records the count in the buzzword candidate table 121.

The accounting unit 17 charges each sponsor for the buzzword for which the sponsor votes proportionally with a sum of vote points and the count of clicks. If the sponsor votes for a plurality of buzzwords, a sum of vote points for the buzzwords is calculated. An example of simplest calculation equations for an instance in which the sponsor casts a vote for a buzzword A will be explained. A point unit price shown below is set by the provider and common to all buzzwords.
[Amounts charged for buzzword A]=[Count of clicks on buzzword A]×[Click unit price]
[Click unit price]=[Vote points for buzzword A]×[Point unit price]

According to the tenth embodiment, the point unit price for the buzzword candidate for which sponsors intensively vote is discounted. On the other hand, according to a twelfth embodiment of the present invention, the same advantage can be expected by calculating the point unit price so that the point unit price is lower if the count of clicks on a buzzword according to the eleventh embodiment is higher.

Therefore, the accounting unit 17 calculates a click unit price for each buzzword based on data on aggregation of vote points from the vote point aggregation unit 114 and the count of clicks from the portal unit 13. Simplest examples of calculation equations for this calculation are as follows.

(i) If the count of clicks is lower than a basic count of clicks:
[Point unit price]=[Basic point unit price]

(ii) If the count of clicks is higher than the basic count of clicks:
[Point unit price]=[Basic point unit price]×√([Basic count of clicks]/[Count of clicks])

The accounting unit 17 calculates an amount charged for the buzzword for which the sponsor votes based on the count of clicks, the vote points, and the point unit price. If the sponsor casts votes for a plurality of buzzwords, the accounting unit 17 calculates a sum of the amounts charged for the buzzwords. A simplest example of a calculation equation for an instance in which the sponsor votes for the buzzword A is as follows.
[Amount charged for buzzword A]=[Count of clicks on buzzword A]×[Vote points for buzzword A]×[Point unit price]

The first to the twelfth embodiments relate to trend creation, which is of high commercial value. Alternatively, the commercial value can be made higher by combining the trend creation with an advertising method.

As the advertising method, a method for displaying an advertisement content of a sponsor and a method for preferentially displaying a search result to a sponsor are provided. Both the advertisement content and the search result that are of close relevance to a buzzword are displayed.

According to a thirteenth embodiment of the present invention, the advertisement content of the sponsor is displayed according to an exposure ratio corresponding to vote points of the sponsor for each buzzword. In addition, while the sponsor is charged for the vote points, the sponsor is simultaneously charged for display of the advertisement content of the sponsor.

A trend-creation-type advertising system according to the thirteenth embodiment is equal in configuration for those according to the first to the twelfth embodiments except that the buzzword voting manager 11 and the search engine unit 14 include additional functions. The additional functions will be explained.

Simultaneously with voting for a buzzword, the sponsor applies for and registers the advertisement content.

The vote registration unit 113 of the buzzword voting manager 11 records the ID of the buzzword candidate for which the sponsor casts a vote, the sponsor ID, the vote points, and the advertisement content applied for in the vote point table 122.

The search engine unit 14 conducts a search using a buzzword (keyword) indicated by a user, selects an advertisement content to be displayed from among those corresponding to the buzzword. In addition, the search engine unit 14 transfers the selected advertisement content together with a content of a search result or a list of contents thereof to the user.

To select the advertisement content, the search engine unit 14 aggregates vote points for every advertisement content registered for the buzzword, and selects the advertisement content so that the advertisement content has an exposure ratio corresponding to the vote points.

According to a fourteenth embodiment of the present invention, the advertisement content of a sponsor is displayed at an exposure ratio corresponding to vote points of the sponsor for each buzzword. Charging is associated with the vote points and an advertisement click unit price.

A trend-creation-type advertising system according to the fourteenth embodiment is equal in configuration to that according to the thirteenth embodiment except that the search engine unit 14 and the accounting unit 17 of the portal site 10 include additional functions. The additional functions will be explained.

After transferring the search result and the advertisement content to the user, the search engine unit 14 counts user's clicks on the advertisement content thus displayed, and records the count of clicks in the vote point table 122 while making it correspond to the advertisement content.

The ID of each buzzword candidate, the sponsor ID, the vote points, the advertisement content, the count of clicks on the advertisement content, and the like are recorded in the vote point table 122.

The accounting unit 17 calculates an amount charged based on the vote points of the sponsor for the buzzword and the count of clicks on the advertisement content. If the sponsor casts votes for a plurality of buzzwords, the accounting unit 17 calculates a sum of the amounts charged for the buzzwords. An example of simplest calculation equations for an instance in which the click unit price is always equal to the point unit price, and the sponsor votes for the buzzword A, and an advertisement content ‘a’ registered corresponding to the buzzword A is clicked on.
[Amount charged for buzzword A]=[Click unit price]×[Count of clicks on advertisement content ‘a’]
[Click unit price]=[Vote points for buzzword A]×[Point unit price]

The creation of a buzzword is associated with the commercial value. If a search result of clicking on the buzzword is a Web page of a sponsor, the commercial value is advantageously higher.

According to a fifteenth embodiment of the present invention, the sponsor is charged based on a combination of vote points and a search result rank.

A trend-creation-type advertising system according to the fifteenth embodiment is equal to those according to the first to the twelfth embodiments except that the buzzword voting manager 11 and the search engine unit 14 of the portal site 10 include additional functions. The additional functions will be explained.

Simultaneously with voting for a buzzword, the sponsor applies for and registers a Web page of the sponsor.

The vote registration unit 113 of the buzzword voting manager 11 records the ID of the buzzword for which the sponsor votes, the sponsor ID, the vote points, and the sponsor Web page applied for in the vote point table 122.

The search engine unit 14 conducts a search using a buzzword (keyword) indicated by a user, selects a sponsor Web page from among those corresponding to the buzzword. In addition, the search engine unit 14 transfers the selected sponsor Web page together with a content of the search result or a list of contents thereof.

To select the sponsor Web page, the search engine unit 14 aggregates vote points for every sponsor Web page registered for the buzzword, and selects the sponsor Web page so that the sponsor Web page has an exposure ratio corresponding to the vote points for the page. For the sponsor Web page, a title, an abstract, and a URL of the page are normally displayed on the search result list. The effect of the sponsor Web page is greater if the sponsor Web page ranks higher on the search result list.

According to a sixteenth embodiment of the present invention, a user's click on a buzzword is directly associated with a sponsor Web page, and a sponsor is charged based on a combination of vote points and a sponsor page click unit price.

A trend-creation-type advertising system according to the sixteenth embodiment is equal in configuration to that according to the fifteenth embodiment except that the search engine unit 14 and the accounting unit 17 of the portal site 10 include additional functions. The additional functions will be explained.

After transferring a search result and a sponsor Web page to a user, the search engine unit 14 counts user's clicks on the sponsor Web page thus displayed, and records the count of clicks in the vote point table 122 while making it correspond to the sponsor Web page.

The buzzword candidate ID, the sponsor ID, the vote points, the sponsor Web page, the count of clicks on the sponsor Web page, and the like are recorded in the vote point table 122.

The accounting unit 17 calculates an amount charged based on the vote points of the sponsor for the buzzword and the number of clicks on the advertisement content of the sponsor. If the sponsor casts votes for a plurality of buzzwords, the accounting unit 17 calculates a sum of amounts charged for the buzzwords. An example of simplest calculation equations for an instance in which the click unit price is always equal to the point unit price, and the sponsor votes for the buzzword A, and the advertisement content ‘a’ registered corresponding to the buzzword A is clicked on.
[Amount charged for buzzword A]=[Click unit price]×[Count of clicks on advertisement content ‘a’]
[Click unit price]=[Vote points for buzzword A]×[Point unit price]

The present invention is not limited to the exemplary embodiments explained so far. Needless to say, the object of the present invention is attained as follows. The respective functions that constitute each embodiment are programmed, resultant programs are written to a recording medium in advance. In addition, these programs recorded in this recording medium are stored in a memory or a storage device included in a computer, and the programs are executed. In this case, the programs read from the recording medium realize the respective functions that constitute each embodiment per se. In addition, the programs and the recording mediums in which the programs are recorded constitute the present invention.

Alternatively, the respective functions that constitute each embodiment are realized by processing the programs jointly with an operating system, the other application program or the like based on indications of the programs.

The programs that realize the respective functions that constitute each embodiment can be provided by a recording medium in an arbitrary form such as a disk recording medium (e.g., a magnetic disk or an optical disk), a card recording medium (e.g., a memory card or an optical card), a semiconductor memory recording medium (e.g., a ROM or a nonvolatile memory), or a tape recording medium (e.g., a magnetic tape or a cassette tape). Alternatively, the programs stored in the storage device can be directly supplied from a server computer through a network. In this case, a storage device of this server computer is included in the recording medium according to the present invention.

As explained so far, by programming the respective functions that constitute each embodiment and distributing the programs, it is possible to reduce cost and enhance portability and versatility.

According to an embodiment of the present invention, it is possible to enhance compatibility of a push keyword search model with an advertisement.

Furthermore according to an embodiment of the present invention, a trend can be created by the push keyword search.

Moreover according to an embodiment of the present invention, a trend creation advertising business model based on the push keyword search can be constructed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A trend-creation-type advertising system comprising:
a buzzword voting manager that manages vote points of each sponsor for each of buzzword candidates selected in advance, and that decides buzzwords based on the vote points;
a buzzword acquiring unit that selects a buzzword to be displayed based on a preset criterion from among the decided buzzwords;
a portal unit that generates a hypertext content that includes a buzzword list or a sentence including the buzzword selected by the buzzword acquiring unit, and that transfers the generated hypertext content to a user terminal; and
a search engine unit that receives a search request with the buzzword as a keyword when a user clicks on the buzzword list or the buzzword in the sentence, and that transfers a search result of contents on a website to a source of the search request.

2. The trend-creation-type advertising system according to claim 1, wherein
the buzzword voting manager discloses the buzzword candidates and display periods of the respective buzzword candidates to allow the each sponsor to cast a vote by designating one of the buzzword candidates, one of the display periods, and the vote points.

3. The trend-creation-type advertising system according to claim 1, wherein
the buzzword voting manager classifies the buzzword candidates according to categories, and discloses the classified buzzword candidates and display periods of the respective classified buzzword candidates.

4. The trend-creation-type advertising system according to claim 3, wherein
the buzzword candidates are classified into buzzwords for unspecified majority of users and buzzwords for a specific user group.

5. The trend-creation-type advertising system according to claim 1, further comprising:
a user preference information acquiring unit that acquires user preference information, wherein
the buzzword acquiring unit selects the buzzword of a high relevance to the user preference information acquired by the user preference information acquiring unit from among the buzzwords decided by the buzzword voting manager.

6. The trend-creation-type advertising system according to claim 1, wherein
the portal unit includes, when generating the hypertext content that includes the buzzword list or the sentence including the buzzword, the buzzword and a count of clicks on the buzzword in the hypertext content.

7. The trend-creation-type advertising system according to claim 5, wherein
the buzzword acquiring unit selects the buzzword in one of the categories of high relevance to the user preference information, and
the portal unit includes, when generating the hypertext content that includes the buzzword list or the sentence including the buzzword, the buzzword and a count of clicks on the buzzword in the hypertext content.

8. The trend-creation-type advertising system according to claim 1, wherein
the buzzword voting manager discloses the buzzword candidates and an auxiliary keyword corresponding to each of the buzzword candidates, and
the search engine unit receives the search request with the buzzword used as the keyword when the user clicks on the buzzword list or the buzzword in the sentence including the buzzword, and transfers the search result of the contents on the website using the buzzword and the auxiliary keyword corresponding to the buzzword to the source of the search request.

9. The trend-creation-type advertising system according to claim 8, wherein
the buzzword voting manager discloses the buzzword candidates, registers and manages an arbitrary number of auxiliary keywords applied for by the sponsor to correspond to each of the buzzword candidates and vote points for the respective auxiliary keywords, the auxiliary keywords being referred to as sponsor keywords, and manages a sum of the vote points for the respective sponsor keywords corresponding to the each buzzword candidate as the vote points for the each buzzword candidate,
the buzzword acquiring unit selects one sponsor keyword based on a preset criterion from among the sponsor keywords corresponding to the selected buzzword, and
the search engine unit receives the search request with the buzzword used as the keyword when the user clicks on the buzzword list or the buzzword in the sentence including the buzzword, and transfers the search result of the contents on the websites using the buzzword and the selected sponsor keyword corresponding to the buzzword to the source of the search request.

10. The trend-creation-type advertising system according to claim 1, further comprising:
an accounting unit that accumulates the vote points of the each sponsor, that calculates an amount of money charged corresponding to the aggregated vote points, and that charges the each sponsor the amount of money for the vote points.

11. The trend-creation-type advertising system according to claim 10, wherein
the buzzword voting manager discloses a list including the buzzword candidates and a point unit price or the vote points when disclosing the buzzword candidates, aggregates the vote points for each of the buzzword candidates at an appropriate time, and calculates the point unit price so that the point unit price is lower if the vote points are higher based on a preset criterion.

12. The trend-creation-type advertising system according to claim 10, wherein
the portal unit counts user's clicks on each of the buzzwords, and
the accounting unit calculates the amount of money charged based on a function f, which is a function of [the count of the user's clicks on a buzzword A], [the vote points for the buzzword A], and [the point unit price], the function f having a relationship that if [the count of the user's clicks on the buzzword A] is higher and if [the vote points for the buzzword A] are higher, the amount of money charged is higher for a vote of the each sponsor for each of the buzzwords.

13. The trend-creation-type advertising system according to claim 12, wherein
the point unit price is lower if the count of user's clicks is higher based on a preset criterion.

14. The trend-creation-type advertising system according to claim 10, wherein
the buzzword voting manager discloses the buzzword candidates, registers and manages the vote points and arbitrary advertisement contents for the respective buzzword candidates for which the each sponsor votes, and selects some of the advertisement contents according to the vote points, and
the search engine unit selects one advertisement content to be displayed based on a preset criterion from among the advertisement contents selected by the buzzword voting manager, and transfers the selected advertisement content as well as a search result content or a search result content list to the user terminal.

15. The trend-creation-type advertising system according to claim 14, wherein
the search engine unit counts user's clicks on the selected advertisement content, and
the accounting unit calculates the amount of money charged based on a function f, which is a function of [the vote points for the buzzword A], [the point unit price], and [the count of the user's clicks on a sponsor advertisement content ‘a’], the function f having a relationship that if [the vote points for the buzzword A] are higher and if [the count of the user's clicks on the sponsor advertisement content ‘a’] is higher, the amount of money charged is higher for a vote of the each sponsor for each of the buzzwords.

16. The trend-creation-type advertising system according to claim 10, wherein
the buzzword voting manager allows the each sponsor to apply for and register arbitrary sponsor pages for each of the buzzword candidates, to vote for the each buzzword, and to select one of the sponsor pages according to the vote points, and
the search engine unit selects one sponsor page to be displayed based on a preset criterion from among the sponsor pages selected by the buzzword voting manager, and transfers the selected sponsor page as well as a search result content or a search result content list to the user terminal.

17. The trend-creation-type advertising system according to claim 16, wherein
the search engine unit counts user's clicks on the selected advertisement content, and
the accounting unit calculates the amount of money charged based on a function f, which is a function of [the vote points for the buzzword A], [the point unit price], and [a count of user's clicks on a sponsor page ‘a’], the function f having a relationship that if [the vote points for the buzzword A] are higher and if [the count of the user's clicks on the sponsor page ‘a’] is higher, the amount of money charged is higher for a vote of the each sponsor for each of the buzzwords.

18. A trend-creation-type advertising system comprising:
a buzzword-candidate collecting unit that collects keywords having high increments in number of times of appearance as buzzword candidates from among keywords in search conditions or contents;
a buzzword voting manager that manages vote points of each sponsor for each of the buzzword candidates collected by the buzzword collecting unit, and that decides buzzwords based on the vote points;
a buzzword acquiring unit that selects a buzzword to be displayed based on a preset criterion from among the decided buzzwords;
a portal unit that generates a hypertext content that includes a buzzword list or a sentence including the buzzword selected by the buzzword acquiring unit, and that transfers the generated hypertext content to a user terminal; and
a search engine unit that receives a search request with the buzzword as a keyword when a user clicks on the buzzword list or the buzzword in the sentence, and that transfers a search result of contents on a website to a source of the search request.

19. The trend-creation-type advertising system according to claim 18, wherein
the buzzword voting manager discloses the buzzword candidates and display periods of the respective buzzword candidates to allow the each sponsor to cast a vote by designating one of the buzzword candidates, one of the display periods, and the vote points.

20. The trend-creation-type advertising system according to claim 18, wherein
the buzzword voting manager classifies the buzzword candidates according to categories, and discloses the classified buzzword candidates and display periods of the respective classified buzzword candidates.

21. The trend-creation-type advertising system according to claim 20, wherein
the buzzword candidates are classified into buzzwords for unspecified majority of users and buzzwords for a specific user group.

22. The trend-creation-type advertising system according to claim 18, further comprising:
a user preference information acquiring unit that acquires user preference information, wherein
the buzzword acquiring unit selects the buzzword of a high relevance to the user preference information acquired by the user preference information acquiring unit from among the buzzwords decided by the buzzword voting manager.

23. The trend-creation-type advertising system according to claim 18, wherein
the portal unit includes, when generating the hypertext content that includes the buzzword list or the sentence including the buzzword, the buzzword and a count of clicks on the buzzword in the hypertext content.

24. The trend-creation-type advertising system according to claim 22, wherein
the buzzword acquiring unit selects the buzzword in one of the categories of high relevance to the user preference information, and
the portal unit includes, when generating the hypertext content that includes the buzzword list or the sentence including the buzzword, the buzzword and a count of clicks on the buzzword in the hypertext content.

25. The trend-creation-type advertising system according to claim 18, wherein
the buzzword voting manager discloses the buzzword candidates and an auxiliary keyword corresponding to each of the buzzword candidates, and
the search engine unit receives the search request with the buzzword used as the keyword when the user clicks on the buzzword list or the buzzword in the sentence including the buzzword, and transfers the search result of the contents on the website using the buzzword and the auxiliary keyword corresponding to the buzzword to the source of the search request.

26. The trend-creation-type advertising system according to claim 25, wherein
the buzzword voting manager discloses the buzzword candidates, registers and manages an arbitrary number of auxiliary keywords applied for by the sponsor to correspond to each of the buzzword candidates and vote points for the respective auxiliary keywords, the auxiliary keywords being referred to as sponsor keywords, and manages a sum of the vote points for the respective sponsor keywords corresponding to the each buzzword candidate as the vote points for the each buzzword candidate,
the buzzword acquiring unit selects one sponsor keyword based on a preset criterion from among the sponsor keywords corresponding to the selected buzzword, and
the search engine unit receives the search request with the buzzword used as the keyword when the user clicks on the buzzword list or the buzzword in the sentence including the buzzword, and transfers the search result of the contents on the websites using the buzzword and the selected sponsor keyword corresponding to the buzzword to the source of the search request.

27. The trend-creation-type advertising system according to claim 18, further comprising:
an accounting unit that accumulates the vote points of the each sponsor, that calculates an amount of money charged corresponding to the aggregated vote points, and that charges the each sponsor the amount of money for the vote points.

28. The trend-creation-type advertising system according to claim 27, wherein
the buzzword voting manager discloses a list including the buzzword candidates and a point unit price or the vote points when disclosing the buzzword candidates, aggregates the vote points for each of the buzzword candidates at an appropriate time, and calculates the point unit price so that the point unit price is lower if the vote points are higher based on a preset criterion.

29. The trend-creation-type advertising system according to claim 27, wherein
the portal unit counts user's clicks on each of the buzzwords, and
the accounting unit calculates the amount of money charged based on a function f, which is a function of [the count of the user's clicks on a buzzword A], [the vote points for the buzzword A], and [the point unit price], the function f having a relationship that if [the count of the user's clicks on the buzzword A] is higher and if [the vote points for the buzzword A] are higher, the amount of money charged is higher for a vote of the each sponsor for each of the buzzwords.

30. The trend-creation-type advertising system according to claim 29, wherein
the point unit price is lower if the count of user's clicks is higher based on a preset criterion.

31. The trend-creation-type advertising system according to claim 27, wherein
the buzzword voting manager discloses the buzzword candidates, registers and manages the vote points and arbitrary advertisement contents for the respective buzzword candidates for which the each sponsor votes, and selects some of the advertisement contents according to the vote points, and
the search engine unit selects one advertisement content to be displayed based on a preset criterion from among the advertisement contents selected by the buzzword voting manager, and transfers the selected advertisement content as well as a search result content or a search result content list to the user terminal.

32. The trend-creation-type advertising system according to claim 31, wherein
the search engine unit counts user's clicks on the selected advertisement content, and
the accounting unit calculates the amount of money charged based on a function f, which is a function of [the vote points for the buzzword A], [the point unit price], and [the count of the user's clicks on a sponsor advertisement content ‘a’], the function f having a relationship that if [the vote points for the buzzword A] are higher and if [the count of the user's clicks on the sponsor advertisement content ‘a’] is higher, the amount of money charged is higher for a vote of the each sponsor for each of the buzzwords.

33. The trend-creation-type advertising system according to claim 27, wherein
the buzzword voting manager allows the each sponsor to apply for and register arbitrary sponsor pages for each of the buzzword candidates, to vote for the each buzzword, and to select one of the sponsor pages according to the vote points, and
the search engine unit selects one sponsor page to be displayed based on a preset criterion from among the sponsor pages selected by the buzzword voting manager, and transfers the selected sponsor page as well as a search result content or a search result content list to the user terminal.

34. The trend-creation-type advertising system according to claim 33, wherein
the search engine unit counts user's clicks on the selected advertisement content, and
the accounting unit calculates the amount of money charged based on a function f, which is a function of [the vote points for the buzzword A], [the point unit price], and [a count of user's clicks on a sponsor page ‘a’], the function f having a relationship that if [the vote points for the buzzword A] are higher and if [the count of the user's clicks on the sponsor page ‘a’] is higher, the amount of money charged is higher for a vote of the each sponsor for each of the buzzwords.

35. A trend-creation-type advertising system comprising:
a buzzword voting manager that manages vote points of each sponsor for each of buzzword candidates registered by the each sponsor, and that decides buzzwords based on the vote points;
a buzzword acquiring unit that selects a buzzword to be displayed based on a preset criterion from among the decided buzzwords;
a portal unit that generates a hypertext content that includes a buzzword list or a sentence including the buzzword selected by the buzzword acquiring unit, and that transfers the generated hypertext content to a user terminal; and
a search engine unit that receives a search request with the buzzword as a keyword when a user clicks on the buzzword list or the buzzword in the sentence, and that transfers a search result of contents on a website to a source of the search request.

36. The trend-creation-type advertising system according to claim 35, wherein
the buzzword voting manager discloses the buzzword candidates and display periods of the respective buzzword candidates to allow the each sponsor to cast a vote by designating one of the buzzword candidates, one of the display periods, and the vote points.

37. The trend-creation-type advertising system according to claim 35, wherein
the buzzword voting manager classifies the buzzword candidates according to categories, and discloses the classified buzzword candidates and display periods of the respective classified buzzword candidates.

38. The trend-creation-type advertising system according to claim 37, wherein
the buzzword candidates are classified into buzzwords for unspecified majority of users and buzzwords for a specific user group.

39. The trend-creation-type advertising system according to claim 35, further comprising:
a user preference information acquiring unit that acquires user preference information, wherein
the buzzword acquiring unit selects the buzzword of a high relevance to the user preference information acquired by the user preference information acquiring unit from among the buzzwords decided by the buzzword voting manager.

40. The trend-creation-type advertising system according to claim 35, wherein
the portal unit includes, when generating the hypertext content that includes the buzzword list or the sentence including the buzzword, the buzzword and a count of clicks on the buzzword in the hypertext content.

41. The trend-creation-type advertising system according to claim 39, wherein
the buzzword acquiring unit selects the buzzword in one of the categories of high relevance to the user preference information, and
the portal unit includes, when generating the hypertext content that includes the buzzword list or the sentence including the buzzword, the buzzword and a count of clicks on the buzzword in the hypertext content.

42. The trend-creation-type advertising system according to claim 35, wherein
the buzzword voting manager discloses the buzzword candidates and an auxiliary keyword corresponding to each of the buzzword candidates, and
the search engine unit receives the search request with the buzzword used as the keyword when the user clicks on the buzzword list or the buzzword in the sentence including the buzzword, and transfers the search result of the contents on the website using the buzzword and the auxiliary keyword corresponding to the buzzword to the source of the search request.

43. The trend-creation-type advertising system according to claim 42, wherein
the buzzword voting manager discloses the buzzword candidates, registers and manages an arbitrary number of auxiliary keywords applied for by the sponsor to correspond to each of the buzzword candidates and vote points for the respective auxiliary keywords, the auxiliary keywords being referred to as sponsor keywords, and manages a sum of the vote points for the respective sponsor keywords corresponding to the each buzzword candidate as the vote points for the each buzzword candidate,
the buzzword acquiring unit selects one sponsor keyword based on a preset criterion from among the sponsor keywords corresponding to the selected buzzword, and
the search engine unit receives the search request with the buzzword used as the keyword when the user clicks on the buzzword list or the buzzword in the sentence including the buzzword, and transfers the search result of the contents on the websites using the buzzword and the selected sponsor keyword corresponding to the buzzword to the source of the search request.

44. The trend-creation-type advertising system according to claim 35, further comprising:
an accounting unit that accumulates the vote points of the each sponsor, that calculates an amount of money charged corresponding to the aggregated vote points, and that charges the each sponsor the amount of money for the vote points.

45. The trend-creation-type advertising system according to claim 44, wherein
the buzzword voting manager discloses a list including the buzzword candidates and a point unit price or the vote points when disclosing the buzzword candidates, aggregates the vote points for each of the buzzword candidates at an appropriate time, and calculates the point unit price so that the point unit price is lower if the vote points are higher based on a preset criterion.

46. The trend-creation-type advertising system according to claim 44, wherein
the portal unit counts user's clicks on each of the buzzwords, and
the accounting unit calculates the amount of money charged based on a function f, which is a function of [the count of the user's clicks on a buzzword A], [the vote points for the buzzword A], and [the point unit price], the function f having a relationship that if [the count of the user's clicks on the buzzword A] is higher and if [the vote points for the buzzword A] are higher, the amount of money charged is higher for a vote of the each sponsor for each of the buzzwords.

47. The trend-creation-type advertising system according to claim 46, wherein
the point unit price is lower if the count of user's clicks is higher based on a preset criterion.

48. The trend-creation-type advertising system according to claim 44, wherein
the buzzword voting manager discloses the buzzword candidates, registers and manages the vote points and arbitrary advertisement contents for the respective buzzword candidates for which the each sponsor votes, and selects some of the advertisement contents according to the vote points, and
the search engine unit selects one advertisement content to be displayed based on a preset criterion from among the advertisement contents selected by the buzzword voting manager, and transfers the selected advertisement content as well as a search result content or a search result content list to the user terminal.

49. The trend-creation-type advertising system according to claim 48, wherein
the search engine unit counts user's clicks on the selected advertisement content, and
the accounting unit calculates the amount of money charged based on a function f, which is a function of [the vote points for the buzzword A], [the point unit price], and [the count of the user's clicks on a sponsor advertisement content ‘a’], the function f having a relationship that if [the vote points for the buzzword A] are higher and if [the count of the user's clicks on the sponsor advertisement content ‘a’] is higher, the amount of money charged is higher for a vote of the each sponsor for each of the buzzwords.

50. The trend-creation-type advertising system according to claim 44, wherein
the buzzword voting manager allows the each sponsor to apply for and register arbitrary sponsor pages for each of the buzzword candidates, to vote for the each buzzword, and to select one of the sponsor pages according to the vote points, and
the search engine unit selects one sponsor page to be displayed based on a preset criterion from among the sponsor pages selected by the buzzword voting manager, and transfers the selected sponsor page as well as a search result content or a search result content list to the user terminal.

51. The trend-creation-type advertising system according to claim 50, wherein
the search engine unit counts user's clicks on the selected advertisement content, and
the accounting unit calculates the amount of money charged based on a function f, which is a function of [the vote points for the buzzword A], [the point unit price], and [a count of user's clicks on a sponsor page ‘a’], the function f having a relationship that if [the vote points for the buzzword A] are higher and if [the count of the user's clicks on the sponsor page ‘a’] is higher, the amount of money charged is higher for a vote of the each sponsor for each of the buzzwords.

52. A trend-creation-type advertising method comprising:
managing vote points of each sponsor for each of buzzword candidates selected in advance;
deciding buzzwords based on the vote points;
selecting a buzzword to be displayed based on a preset criterion from among the decided buzzwords;
generating a hypertext content that includes a buzzword list or a sentence including the buzzword selected at the selecting;
transferring the generated hypertext content to a user terminal;
receiving a search request with the buzzword as a keyword when a user clicks on the buzzword list or the buzzword in the sentence; and
transferring a search result of contents on a website to a source of the search request.

53. A trend-creation-type advertising method comprising:
collecting keywords having high increments in number of times of appearance as buzzword candidates from among keywords in search conditions or contents;
managing vote points of each sponsor for each of the buzzword candidates collected at the collecting;
deciding buzzwords based on the vote points;
selecting a buzzword to be displayed based on a preset criterion from among the decided buzzwords;
generating a hypertext content that includes a buzzword list or a sentence including the buzzword selected at the selecting;
transferring the generated hypertext content to a user terminal;
receiving a search request with the buzzword as a keyword when a user clicks on the buzzword list or the buzzword in the sentence; and
transferring a search result of contents on a website to a source of the search request.

54. A trend-creation-type advertising method comprising:
managing vote points of each sponsor for each of buzzword candidates registered by the each sponsor;
deciding buzzwords based on the vote points;
selecting a buzzword to be displayed based on a preset criterion from among the decided buzzwords;
generating a hypertext content that includes a buzzword list or a sentence including the buzzword selected at the selecting;
transferring the generated hypertext content to a user terminal;
receiving a search request with the buzzword as a keyword when a user clicks on the buzzword list or the buzzword in the sentence; and
transferring a search result of contents on a website to a source of the search request.

55. A computer-readable recording medium that stores a computer program for a trend-creation-type advertising system, wherein
the computer program causes a computer to execute:
managing vote points of each sponsor for each of buzzword candidates selected in advance;
deciding buzzwords based on the vote points;
selecting a buzzword to be displayed based on a preset criterion from among the decided buzzwords;
generating a hypertext content that includes a buzzword list or a sentence including the buzzword selected at the selecting;
transferring the generated hypertext content to a user terminal;
receiving a search request with the buzzword as a keyword when a user clicks on the buzzword list or the buzzword in the sentence; and
transferring a search result of contents on a website to a source of the search request.

56. A computer-readable recording medium that stores a computer program for a trend-creation-type advertising system, wherein
the computer program causes a computer to execute:
collecting keywords having high increments in number of times of appearance as buzzword candidates from among keywords in search conditions or contents;
managing vote points of each sponsor for each of the buzzword candidates collected at the collecting;
deciding buzzwords based on the vote points;
selecting a buzzword to be displayed based on a preset criterion from among the decided buzzwords;
generating a hypertext content that includes a buzzword list or a sentence including the buzzword selected at the selecting;
transferring the generated hypertext content to a user terminal;
receiving a search request with the buzzword as a keyword when a user clicks on the buzzword list or the buzzword in the sentence; and
transferring a search result of contents on a website to a source of the search request.

57. A computer-readable recording medium that stores a computer program for a trend-creation-type advertising system, wherein
the computer program causes a computer to execute:
managing vote points of each sponsor for each of buzzword candidates registered by the each sponsor;
deciding buzzwords based on the vote points;
selecting a buzzword to be displayed based on a preset criterion from among the decided buzzwords;
generating a hypertext content that includes a buzzword list or a sentence including the buzzword selected at the selecting;
transferring the generated hypertext content to a user terminal;
receiving a search request with the buzzword as a keyword when a user clicks on the buzzword list or the buzzword in the sentence; and
transferring a search result of contents on a website to a source of the search request.
